(19) United States
(12) Patent Application Publication
(10) Pub. No.: US 2026/0039026 A1
(43) Pub. Date: Feb. 5, 2026

(54) SUBSTRATE INTEGRATED WAVEGUIDE ANTENNA AND ARRAY ANTENNA

(71) Applicant: Fujitsu Limited, Kawasaki-shi (JP)

(72) Inventors: NAOYA OKAMOTO, Isehara (JP); Shirou OZAKI, Yamato (JP); YASUHIRO NAKASHA, Hadano (JP); Naoki HARA, Sagamihara (JP)

(73) Assignee: Fujitsu Limited, Kawasaki-shi (JP)

(21) Appl. No.: 19/341,693

(22) Filed: Sep. 26, 2025

Related U.S. Application Data
(63) Continuation of application No. PCT/JP2024/009275, filed on Mar. 11, 2024.

(30) Foreign Application Priority Data
Mar. 30, 2023 (JP) 2023-054823

(51) Int. Cl. H01Q 19/10; H01Q 1/22; H01Q 21/00

(52) U.S. Cl. CPC H01Q 19/10; H01Q 1/2283; H01Q 21/00

(57) ABSTRACT

A substrate integrated waveguide antenna includes, a substrate integrated waveguide, a radiator including a plurality of metal strips, and a metal wall, wherein the substrate integrated waveguide and the radiator are connected on a dielectric substrate, and the metal wall is disposed at a second position with a second distance longer than a first distance in a direction toward the substrate integrated waveguide from a first position, the first position being a position with the first distance in a direction from an interface at which the substrate integrated waveguide and the radiator are connected toward the radiator.

### CROSS-REFERENCE TO RELATED APPLICATION

This application is a continuation application under 35 U.S.C. 111(a) of International Application No. PCT/JP2024/009275, filed on Mar. 11, 2024, now pending, which claims priority of Japanese Patent Application No. 2023-054823, filed on Mar. 30, 2023, the entire contents of each are incorporated herein by reference.

### FIELD

The present disclosure relates to a substrate integrated waveguide antenna and an array antenna.

### BACKGROUND

In the next generation communication Beyond 5G/6G, for example, in order to realize a communication speed of about 100 Gbps, use of radio waves in the sub-terahertz band has been studied. Since a compound semiconductor amplifier can perform high-frequency and high-output operation as compared with a silicon-based amplifier, application to the Beyond 5G/6G is expected as a sub-terahertz band semiconductor amplifier.

On the other hand, since the sub-terahertz band has rectilinear propagation of radio waves, beam control by an array antenna in mobile communication may be required. In a sub-terahertz band antenna, the size of a semiconductor amplifier may be larger than the size of a planar antenna such as a patch antenna used in the millimeter wave band. Therefore, it is difficult to realize an array antenna in which an amplifier and a planar antenna are mounted in a one-to-one correspondence. Therefore, a three-dimensional stacked antenna array structure in which an amplifier and an antenna are easily mounted in a one-to-one correspondence has been proposed.

Examples of sub-terahertz band amplifiers include a high electron mobility transistor (InP-based HEMT) in which an indium aluminum arsenide (InAlAs) electron supply layer/an indium gallium arsenide (InGaAs) channel layer is formed on an indium phosphide (InP) substrate, an HEMT (Metamorphic HEMT, mHEMT) in which an InAlAs electron supply layer/an InGaAs channel layer is formed on a gallium arsenide (GaAs) substrate via a metamorphic buffer layer, and a heterojunction bipolar transistor (InP-based HBT) in which an InP emitter layer/a gallium arsenide antimony (GaAsSb) base layer/an In (Al) GaAs collector layer and the like are formed on an InP substrate. Since these compound semiconductor amplifiers can perform high-frequency and high-output operation as compared with silicon-based amplifiers, application to the Beyond 5G/6G is expected.

Techniques related to antennas are described in WO 2016/111107 A, JP 2011-109438 A, and WO 2019/008852 A.

### SUMMARY

According to an aspect of the embodiments, a substrate integrated waveguide antenna includes, a substrate integrated waveguide, a radiator including a plurality of metal strips, and a metal wall, wherein the substrate integrated waveguide and the radiator are connected on a dielectric substrate, and the metal wall is disposed at a second position with a second distance longer than a first distance in a direction toward the substrate integrated waveguide from a first position, the first position being a position with the first distance in a direction from an interface at which the substrate integrated waveguide and the radiator are connected toward the radiator.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1A is a diagram illustrating a configuration example of an antenna 100.

FIG. 1B is a diagram illustrating a configuration example of the antenna 100.

FIG. 1C is a diagram illustrating a configuration example of the antenna 100.

FIG. 2A illustrates an example of a simulation result in the antenna 100.

FIG. 2B illustrates an example of a simulation result in the antenna 100.

FIG. 2C illustrates an example of a simulation result in the antenna 100.

FIG. 3A is a diagram illustrating an example of a method of manufacturing the antenna 100.

FIG. 3B is a diagram illustrating an example of a method of manufacturing the antenna 100.

FIG. 3C is a diagram illustrating an example of a method of manufacturing the antenna 100.

FIG. 3D is a diagram illustrating an example of a method of manufacturing the antenna 100.

FIG. 3E is a diagram illustrating an example of a method of manufacturing the antenna 100.

FIG. 3F is a diagram illustrating an example of a method of manufacturing the antenna 100.

FIG. 3G is a diagram illustrating an example of a method of manufacturing the antenna 100.

FIG. 3H is a diagram illustrating an example of a method of manufacturing the antenna 100.

FIG. 3I is a diagram illustrating an example of a method of manufacturing the antenna 100.

FIG. 3J is a diagram illustrating an example of a method of manufacturing the antenna 100.

FIG. 3K is a diagram illustrating an example of a method of manufacturing the antenna 100.

FIG. 3L is a diagram illustrating an example of a method of manufacturing the antenna 100.

FIG. 4A is a diagram illustrating a configuration example of an antenna 200.

FIG. 4B is a diagram illustrating a configuration example of the antenna 200.

FIG. 5 illustrates an example of a simulation result of the antenna 200.

FIG. 6A is a diagram illustrating an example of a method of manufacturing the antenna 200.

FIG. 6B is a diagram illustrating an example of a method of manufacturing the antenna 200.

FIG. 6C is a diagram illustrating an example of a method of manufacturing the antenna 200.

FIG. 6D is a diagram illustrating an example of a method of manufacturing the antenna 200.

FIG. 6E is a diagram illustrating an example of a method of manufacturing the antenna 200.

FIG. 6F is a diagram illustrating an example of a method of manufacturing the antenna 200.

FIG. 7A is a diagram illustrating a configuration example of an antenna array 300.

FIG. 7B is a diagram illustrating a configuration example of the antenna array 300.

FIG. 8A illustrates an example of a simulation result in the antenna array 300.

FIG. 8B illustrates an example of a simulation result in the antenna array 300.

FIG. 8C illustrates an example of a simulation result in the antenna array 300.

FIG. 8D illustrates an example of a simulation result in the antenna array 300.

FIG. 9A is a diagram illustrating an example of a method of manufacturing the antenna array 300.

FIG. 9B is a diagram illustrating an example of a method of manufacturing the antenna array 300.

FIG. 9C is a diagram illustrating an example of a method of manufacturing the antenna array 300.

FIG. 9D is a diagram illustrating an example of a method of manufacturing the antenna array 300.

FIG. 9E is a diagram illustrating an example of a method of manufacturing the antenna array 300.

FIG. 10A is a diagram illustrating a configuration example of an antenna array 400.

FIG. 10B is a diagram illustrating a configuration example of the antenna array 400.

FIG. 11A illustrates an example of a simulation result of the antenna array 400.

FIG. 11B illustrates an example of a simulation result of the antenna array 400.

FIG. 11C illustrates an example of a simulation result of the antenna array 400.

FIG. 12A is a diagram illustrating an example of a method of manufacturing the antenna array 400.

FIG. 12B is a diagram illustrating an example of a method of manufacturing the antenna array 400.

FIG. 12C is a diagram illustrating an example of a method of manufacturing the antenna array 400.

FIG. 13A is a diagram illustrating a configuration example of an antenna array 500.

FIG. 13B is a diagram illustrating a configuration example of the antenna array 500.

FIG. 14A illustrates an example of a simulation result of the antenna array 500.

FIG. 14B illustrates an example of a simulation result of the antenna array 500.

FIG. 14C illustrates an example of a simulation result of the antenna array 500.

FIG. 15A is a diagram illustrating an example of a method of manufacturing the antenna array 500.

FIG. 15B is a diagram illustrating an example of a method of manufacturing the antenna array 500.

FIG. 15C is a diagram illustrating an example of a method of manufacturing the antenna array 500.

FIG. 15D is a diagram illustrating an example of a method of manufacturing the antenna array 500.

FIG. 15E is a diagram illustrating an example of a method of manufacturing the antenna array 500.

FIG. 15F is a diagram illustrating an example of a method of manufacturing the antenna array 500.

FIG. 15G is a diagram illustrating an example of a method of manufacturing the antenna array 500.

FIG. 15H is a diagram illustrating an example of a method of manufacturing the antenna array 500.

FIG. 16A is a diagram illustrating a configuration example of an antenna array 600.

FIG. 16B is a diagram illustrating a configuration example of the antenna array 600.

FIG. 17A is a diagram illustrating a configuration example of an antenna module 700.

FIG. 17B is a diagram illustrating a configuration example of the antenna module 700.

FIG. 18A is a diagram illustrating a configuration example of an antenna module 800.

FIG. 18B is a diagram illustrating a configuration example of the antenna module 800.

FIG. 19 is a diagram illustrating a configuration example of an antenna module 900.

FIG. 20A is a diagram illustrating a configuration example of an antenna module 1000.

FIG. 20B is a diagram illustrating a configuration example of the antenna module 1000.

FIG. 21 illustrates an example of a table regarding dielectric constant, dielectric loss, and thermal conductivity of substances.

### DESCRIPTION OF EMBODIMENTS

There is no antenna that can appropriately support next-generation communication. For example, an antenna having a horn part has a high antenna gain of a single body, but since an antenna interval becomes larger than the wavelength of a predetermined frequency, beam control (angle, grating lobe) may be difficult.

On the other hand, in an antenna without a horn part, since the antenna interval can be made smaller than the wavelength of a predetermined frequency, beam control becomes easy, but the antenna gain of the single body becomes low.
As described above, improvement in the antenna gain and reduction in the antenna interval may be in a contradictory relationship, and it is difficult to achieve both.
Therefore, one disclosure provides a substrate integrated waveguide antenna and an array antenna that achieve both improvement in antenna gain and reduction in antenna interval.

### First Embodiment

A first embodiment will be described.

### Configuration Example of Antenna in First Embodiment

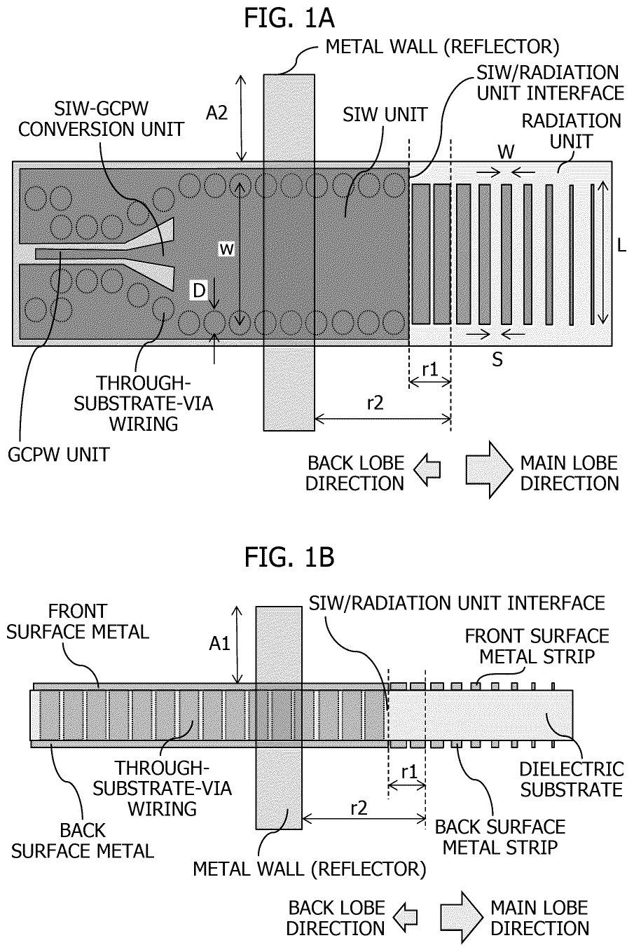

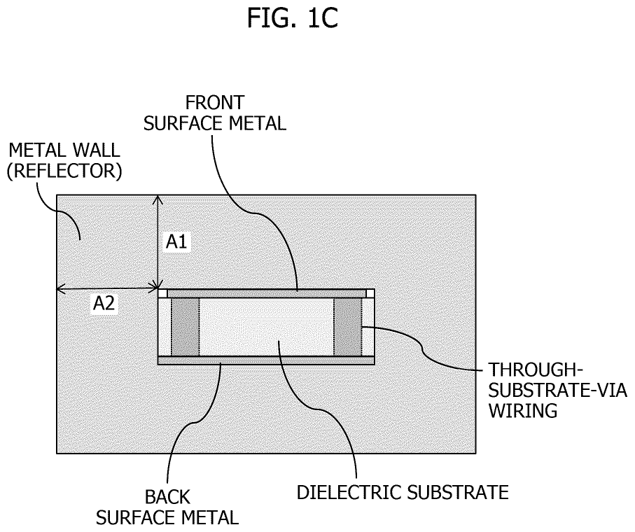

FIGS. 1A to 1C are diagrams illustrating a configuration example of an antenna 100. FIG. 1A illustrates an example of a top view of the antenna 100, FIG. 1B illustrates an example of a cross-sectional view of the antenna 100, and FIG. 1C illustrates an example of a front view of the antenna 100.

The antenna 100 is, for example, an SIW (substrate integrated waveguide) antenna including an SIW unit (substrate integrated waveguide) and a radiation unit (radiator) including a plurality of metal strips. In the antenna 100, a metal wall (reflector) surrounding the SIW unit is disposed at a position with a second distance (r2) in the back lobe direction from a position with a first distance (r1) that is a distance from the interface between the SIW unit and the radiation unit in the main lobe direction at a predetermined frequency. The second distance (r2) is longer than the first distance (r1). The metal wall is a plate-like metal having a predetermined width, and is disposed, for example, so as to be parallel (substantially parallel) to the interface. r1 is ½ wavelength (λ/2) in the dielectric substrate at a predetermined frequency, and r2 is in a range of λ/2−λ/10 to λ/2+λ/5 of the air (wavelength in the air at a certain frequency). The metal wall (reflector) has an outer periphery having a first width (A1) from the front and back surfaces of the SIW unit and a second width (A2) from a side surface of the SIW unit, and the first width (A1) is at least larger than λ/10 of the air. In addition, the SIW unit width (w) is set within a range of the TE10 mode (single mode) at a predetermined frequency. The length (L) of the metal strip of the radiation unit is within ½ of w±through-substrate-via diameter (D). In addition, the ratio between the width (W) and the spacing(S) of each metal strip of the radiation unit is gradually decreased in the main lobe direction. For example, it is preferable that the sum of S and W of each metal strip is λ/4 of the dielectric substrate at a predetermined frequency, and that the ratio of S:W is gradually changed from 1:9 to 9:1 in the main lobe direction.

### Effect of Antenna in First Embodiment

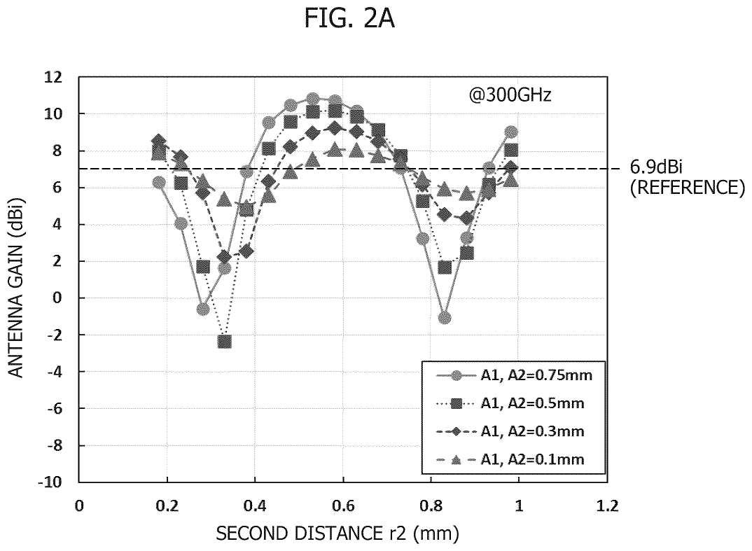

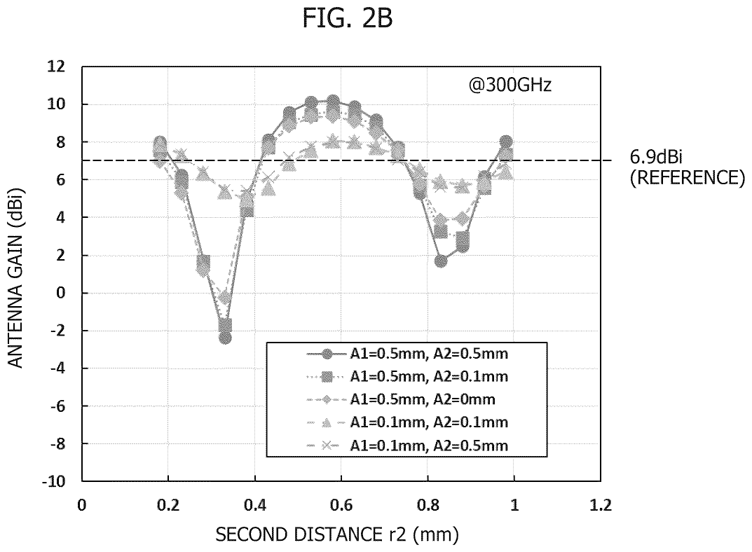

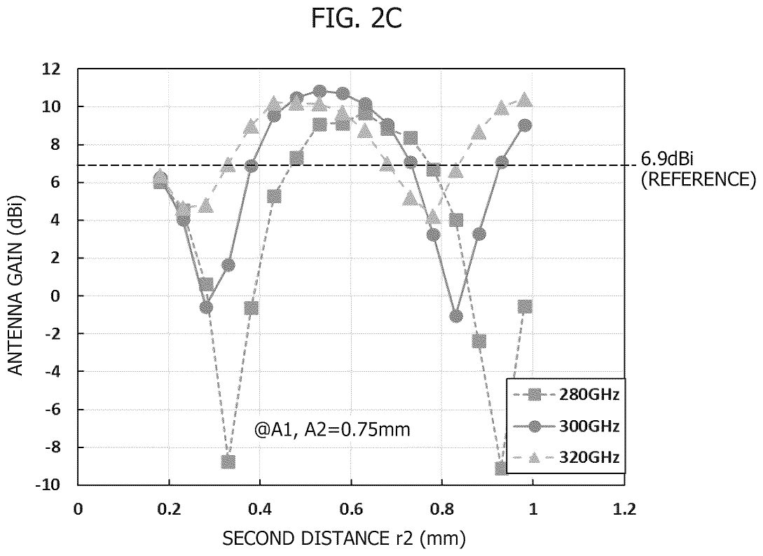

An effect of the antenna 100 in the first embodiment will be described. FIGS. 2A to 2C illustrate examples of simulation results in the antenna 100.

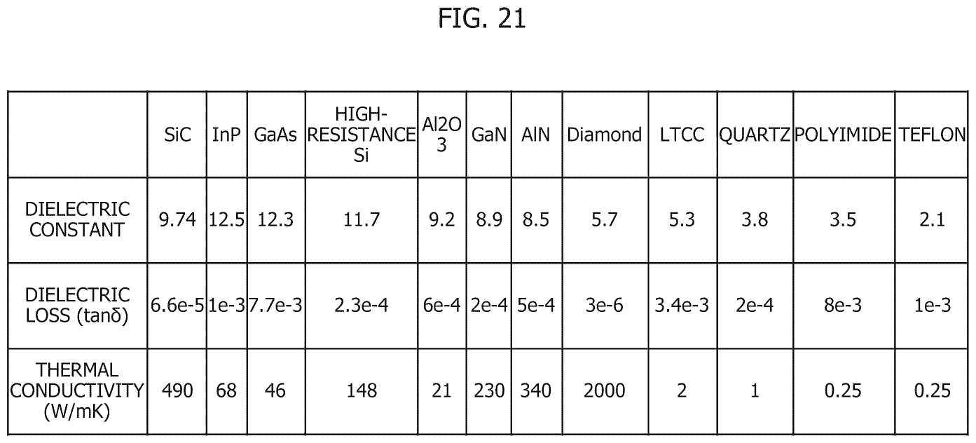

FIG. 2A illustrates an example of simulation results of the second distance (r2) dependency of the antenna gain of an SIW antenna structure having a metal wall with an outer periphery in which the first width (A1) and the second width (A2) are the same. A1 and A2 are set to 0.1 mm, 0.3 mm, 0.5 mm, and 0.75 mm. The horizontal axis of the graph represents the second distance (r2), and the vertical axis represents the antenna gain. The dielectric substrate is an SiC substrate and has a substrate thickness of 100 μm. The SIW unit width (w) is set to 0.48 mm within the range of the TE10 mode. The diameter of the through-substrate-via wiring is set to 80 μm. The length (L) of the metal strip is 0.48 mm that is the same as the SIW unit width. The sum of the spacing(S) and the width (W) of each metal strip is ¼ wavelength (λ/4) of the dielectric substrate at a predetermined frequency, and the ratio of S:W is gradually changed from 1:9 to 9:1 in the main lobe direction. λ/4 in the SiC substrate having a dielectric constant of 9.74 (see Table 1 in FIG. 21) is 80 μm at 300 GHz. The first distance (r1) is a distance from the interface between the SIW unit and the radiation unit to a point indicating the highest electric field intensity in the radiation unit (by simulation), and is set to 160 μm corresponding to λ/2 in the SiC substrate at 300 GHz. The distance from the point indicating the highest electric field intensity in the radiation unit to the metal wall is the second distance (r2).

The antenna gain of the SIW antenna structure with the metal wall (reflector) of A1, A2=0.75 mm increases to be larger than the antenna gain 6.9 dBi of the reference structure in the range of the second distance (r2) of 0.4 mm to 0.7 mm. This r2=0.4 mm to 0.7 mm corresponds to the range of λ/2−λ/10 to λ/2+λ/5 of the air. Although the antenna gain decreases as the width (A1, A2) of the outer periphery of the metal wall decreases, the antenna gain can be improved as compared with the reference structure even when A1, A2=0.1 mm or more. This A1, A2=0.1 mm corresponds to λ/10 of the air.

The expression such as “corresponding to . . . (wavelength) of the air” may be paraphrased as, for example, “corresponding to a wavelength of a predetermined frequency in the air”.

FIG. 2B illustrates an example of simulation results of the second distance (r2) dependency of the antenna gain of an SIW antenna structure having a metal wall with an outer periphery in which the first width (A1) and the second width (A2) are different from each other. In the case of A1=0.5 mm, A2=0 mm, 0.1 mm, and 0.5 mm, and in the case of A1=0.1 mm, A2=0.1 mm, and 0.5 mm. The other conditions are the same as those in FIG. 2A.

When A1=0.5 mm, the antenna gain increases to be larger than the antenna gain 6.9 dBi of the reference structure in the range where the second distance (r2) is 0.4 mm to 0.7 mm. This r2=0.4 mm to 0.7 mm corresponds to the range of λ/2−λ/10 to λ/2+λ/5 of the air. In addition, the antenna gain slightly decreases as A2 decreases, but the maximum antenna gain is 9.4 dBi even when A2=0 mm, indicating a high value. On the other hand, in the case of A1=0.1 mm, the antenna gain increases to be larger than the antenna gain 6.9 dBi of the reference structure in the range where the second distance (r2) is 0.4 mm to 0.7 mm, but even if A2 is expanded to 0.5 mm, the maximum antenna gain becomes 8 dBi, which is the same as the case of A2=0.1 mm.

FIG. 2C illustrates an example of simulation results of the second distance (r2) dependency of the antenna gain of an SIW antenna structure having a metal wall at each frequency. In the case where the width (A1, A2) of the outer periphery of the metal wall is 0.75 mm, the antenna gain is improved in the range where the second distance (r2) is 0.5 mm to 0.65 mm even in a frequency band of 280 GHz to 320 GHz (band 40 GHz), and a wide band of 10% or more of the center frequency (300 GHz) is enabled. This r2=0.5 mm to 0.65 mm corresponds to the range of λ/2 to λ/2+3λ/20 of the air.

When the metal wall (reflector) surrounding the SIW is disposed at a position retracted by λ/4 of the air in the back lobe direction from a position advanced by λ/2 of the dielectric substrate in the main lobe direction from the interface between the SIW unit and the radiation unit at a predetermined frequency, the reflected wave has an opposite phase to the traveling wave, and thus the antenna gain decreases. On the other hand, when the metal wall (reflector) surrounding the SIW is disposed at a position retracted by λ/2 of the air, the reflected wave has the same phase as the traveling wave, and thus the antenna gain is improved. Accordingly, it is considered that the above event occurs.

Furthermore, since the phase shift is smaller than λ/4 in the range of r2=λ/2−λ/10 to λ/2+λ/5, the effect of improving the antenna gain is maintained. In addition, when the width of the outer periphery of the metal wall is narrowed, the reflection area is reduced, and the electric field goes around to the upper and lower surfaces of the metal wall, so that the peak value of the antenna gain decreases and r2 that becomes a peak extends. Similarly, since the electric field goes around to the upper and lower side surfaces of the metal wall, the antenna gain strongly depends on the first width (A1), but hardly goes around to the left and right side surfaces of the metal wall, and thus the second width (A2) is not so dominant. For this reason, A2 may be omitted, but electrical connection is desirable in order to make the potential of the metal wall (reflector) the same. In addition, in the case of a band of 40 GHz with the center frequency of 300 GHz (280 GHz to 320 GHz), a width of λ/2 of the air is about ±λ/30, which is sufficiently within the above-described phase shift range, and thus, a wide band can be realized.

As described above, in the SIW antenna structure according to the first embodiment, the antenna gain can be improved without providing an SIW horn. Therefore, even in the case of arraying, the antenna interval can be shortened.

### Method of Manufacturing Antenna in First Embodiment

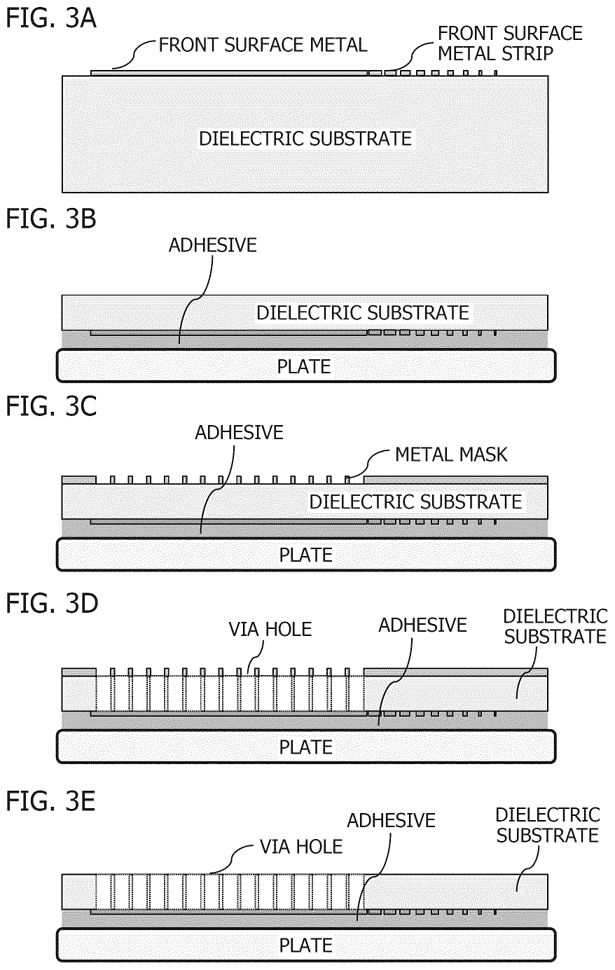

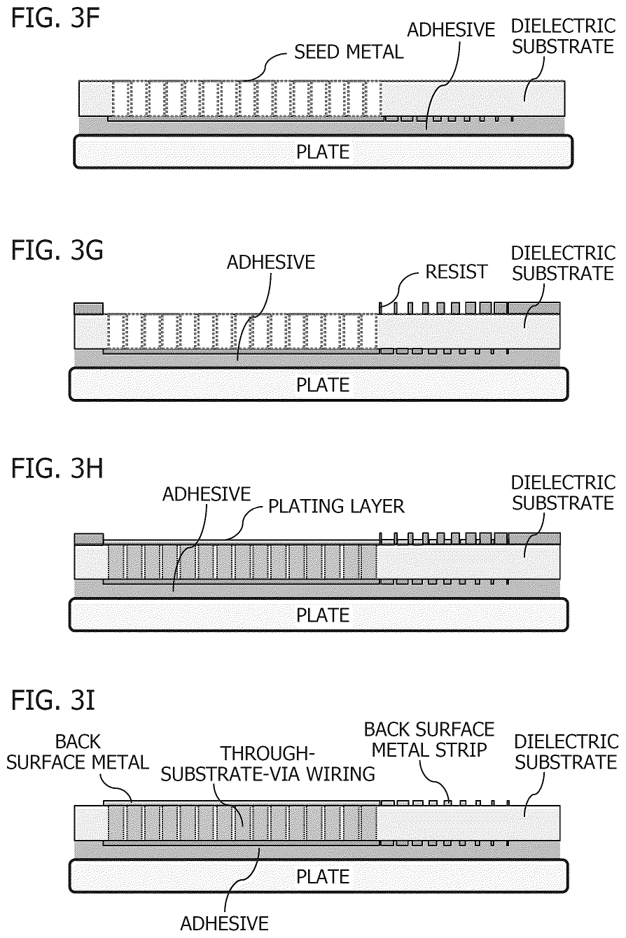

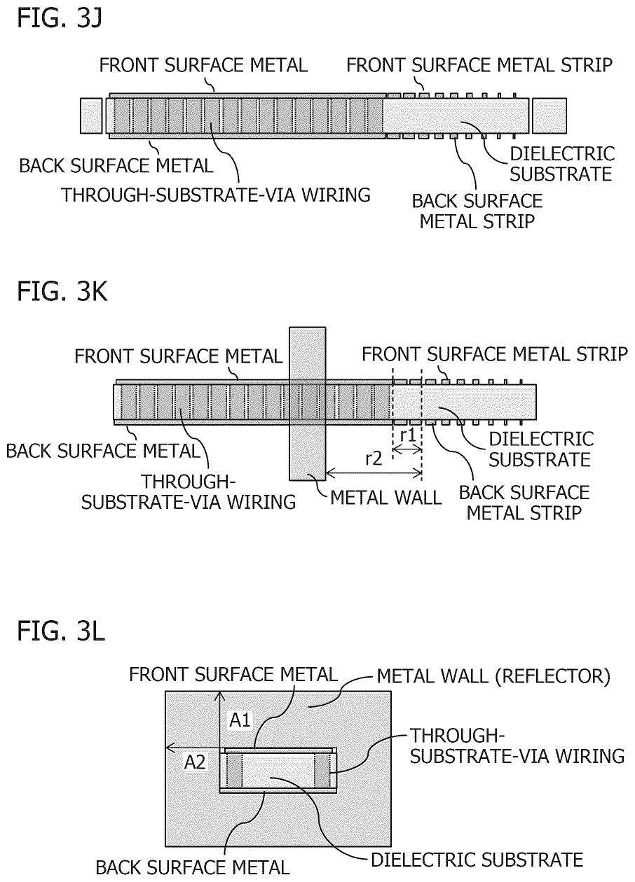

An example of a method of manufacturing an antenna in the first embodiment will be described. FIGS. 3A to 3L illustrate an example of a method of manufacturing the antenna 100. FIGS. 3A to 3L each illustrate, for example, a method of manufacturing the antenna 100 for each process. FIGS. 3A to 3L illustrate, for example, products in the middle and at the time of completion (such as the antenna 100 in the middle of being created) in the method of manufacturing the antenna 100.

### FIG. 3A: Surface Process

An SiC substrate is used as a dielectric substrate, and a wafer in which a surface metal and a surface metal strip are formed on a surface of the SiC substrate is prepared. The surface metal and the surface metal strip are composed of, for example, a nickel (Ni)/gold (Au) structure, and are prepared using a technique such as patterning, vacuum deposition, sputtering, or plating. The Ni layer is at least 0.1 μm or more in order to perform a via etching stopper function.

### FIG. 3B: Substrate Thinning

After the wafer surface is applied with an adhesive and attached to the support substrate, grinding and polishing are performed from the SiC substrate back surface side to reduce the SiC substrate thickness to 100 μm.

### FIG. 3C: Metal Mask Formation

A metal mask is formed on the back surface of the SiC substrate. The metal mask includes, for example, a titanium (Ti)/copper (Cu)/Ni structure, and is prepared by using a technique such as patterning, vacuum deposition, sputtering, or plating. The Ni film thickness is determined by a selection ratio of dry etching used for subsequent via hole formation. For example, when the selection ratio is 100, the Ni film thickness needs to be at least 1 μm or more. The Ni film thickness is, for example, 2 μm. The diameter of the metal mask opening forming the via hole is 80 μm.

### FIG. 3D: Via Etching

Dry etching is performed on the SiC substrate using a mixed gas of sulfur hexafluoride (SF6) and oxygen (O2) to form a via hole penetrating the substrate. At this time, etching is performed at a dry etching rate of 1.6 μm/min for 68 minutes. The etching amount of SiC is about 109 μm, and the Ni layer of the front surface metal sufficiently functions as an etching stopper.

### FIG. 3E: Metal Mask Removal

The metal mask remaining after the dry etching is removed. Here, the front surface metal is protected by patterning, and the metal mask is etched using an etchant such as an acid.

### FIG. 3F: Seed Metal Deposition

A seed metal is deposited in the via hole as well as on the back surface of the SiC substrate. Here, the seed metal includes a Ti/Au layer and is formed by sputtering. An Au layer having a film thickness of at least about 1 μm is deposited on the back surface of the SiC substrate so that the seed metal in the via hole is not disconnected.

### FIG. 3G: Patterning

Patterning is performed so as to open a portion where the back side metal and the back surface metal strip are formed. The resist thickness is 11 μm or more.

### FIG. 3H: Plating

A 10 μm-thick Au-plating layer is formed.

### FIG. 3I: Seed Metal Removal

After the resist is peeled off, the seed metal is removed. Here, the metal in the via hole is protected by patterning, and the Ti/Au layer is etched using an etchant such as an acid. Thus, the back surface metal, the back surface metal strip, and the through-substrate-via wiring are formed. Then, after the wafer is peeled off from the support substrate, the adhesive is removed with an organic solvent.

### FIG. 3J: Chipping

The back surface of the wafer is attached to a dicing tape and formed into chips by ultrasonic blade dicing.

### FIG. 3K: Metal Wall Mounting

By mounting a chipped SIW antenna on a metal wall (reflector) having an opening of the same size as the SIW antenna at a predetermined position, the SIW antenna structure is completed. For example, at 300 GHz, r1 is 0.16 mm, and r2 in which the antenna gain is improved is in the range of 0.4 mm to 0.7 mm, but r2 is desirably in the range of 0.5 mm to 0.65 mm.

FIG. 3L is a front view of the completed SIW antenna structure (antenna 100) in the manufacturing method described above. The width (A1, A2) of the outer periphery of the metal wall is at least 0.1 mm or more.

### Modification of First Embodiment

A modification of the first embodiment will be described.

### Configuration Example of Antenna in Modification of First Embodiment

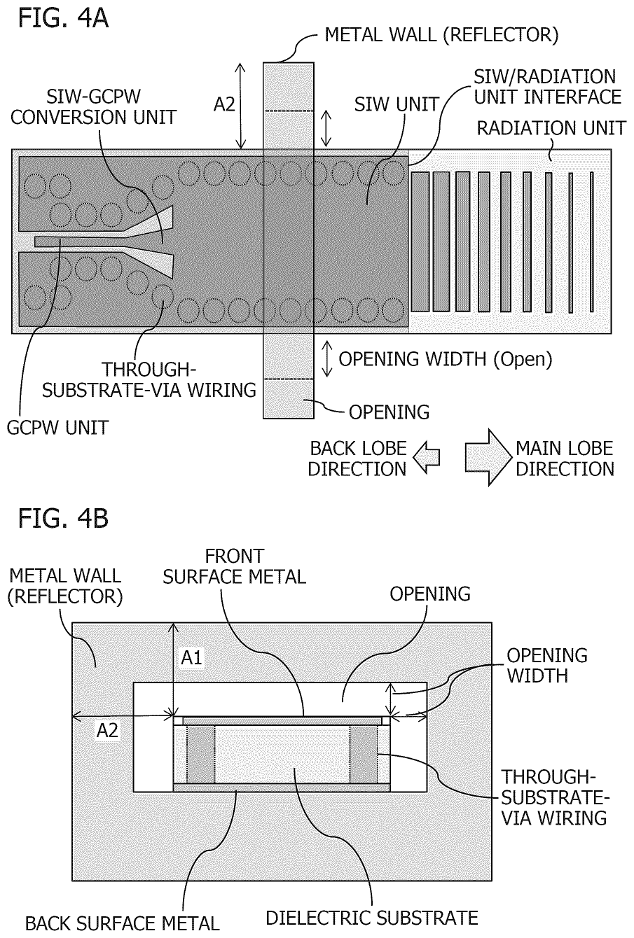

FIGS. 4A and 4B are diagrams illustrating a configuration example of an antenna 200. FIG. 4A illustrates an example of a top view of the antenna 200, and FIG. 4B illustrates an example of a front view of the antenna 200.

As illustrated in FIGS. 4A and 4B, the SIW antenna (antenna 200) according to a modification of the first embodiment has an opening between the SIW unit and the metal wall (reflector).

### Effect of Antenna in Modification of First Embodiment

The antenna 200 in the modification of the first embodiment also has the same effect as the antenna 100 in the first embodiment. According to FIGS. 4A and 4B, the antenna 200 has a configuration in which the metal wall (reflector) and the back surface metal of the SIW unit are in contact with each other, and the upper surface and the side surface of the SIW unit are separated from the metal wall by an opening width (Open) in the top view and the front view, respectively.

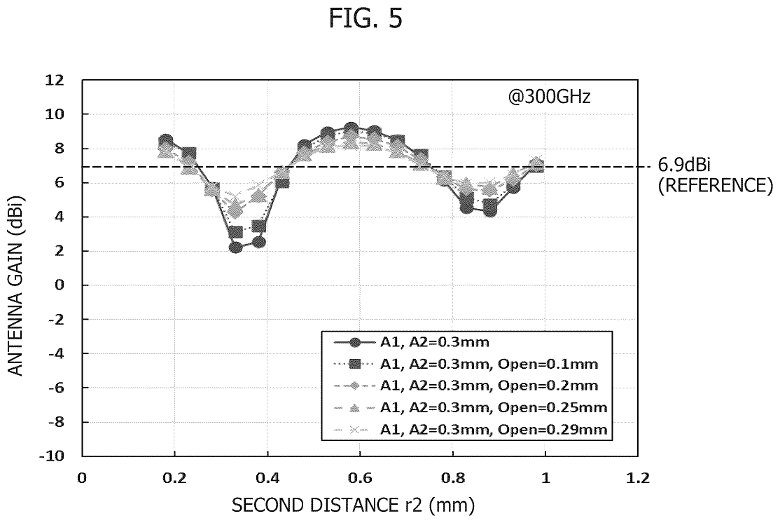

FIG. 5 is a diagram illustrating an example of simulation results of the second distance (r2) dependency of the antenna gain of the SIW antenna structures (antennas 200) having metal walls (reflectors) with different opening widths (Open). The horizontal axis represents the second distance (r2), and the vertical axis represents the antenna gain. The width (A1, A2) of the outer periphery of the metal wall (reflector) is set to 0.3 mm. Although the antenna gain slightly decreases as the opening width (Open) increases, the antenna gain increases to be larger than the antenna gain 6.9 dBi of the reference structure in the range where the second distance (r2) is 0.45 mm to 0.75 mm as in the first embodiment. When the opening width (Open) increases, the reflection area decreases, so that the peak value of the antenna gain decreases. On the other hand, as compared with the case of A2=0.75 mm, since the electric field goes around to the upper and lower surfaces of the metal wall (reflector), r2 slightly extends (0.05 mm), but since the positions of the upper and lower surfaces of the metal wall (reflector) do not change, r2 as a peak does not change.

As described above, in the SIW antenna structure (antenna 200) according to the modification of the first embodiment, the antenna gain can be improved even if there is a gap (opening) between the metal wall and the SIW antenna.

### Method of Manufacturing Antenna in Modification of First Embodiment

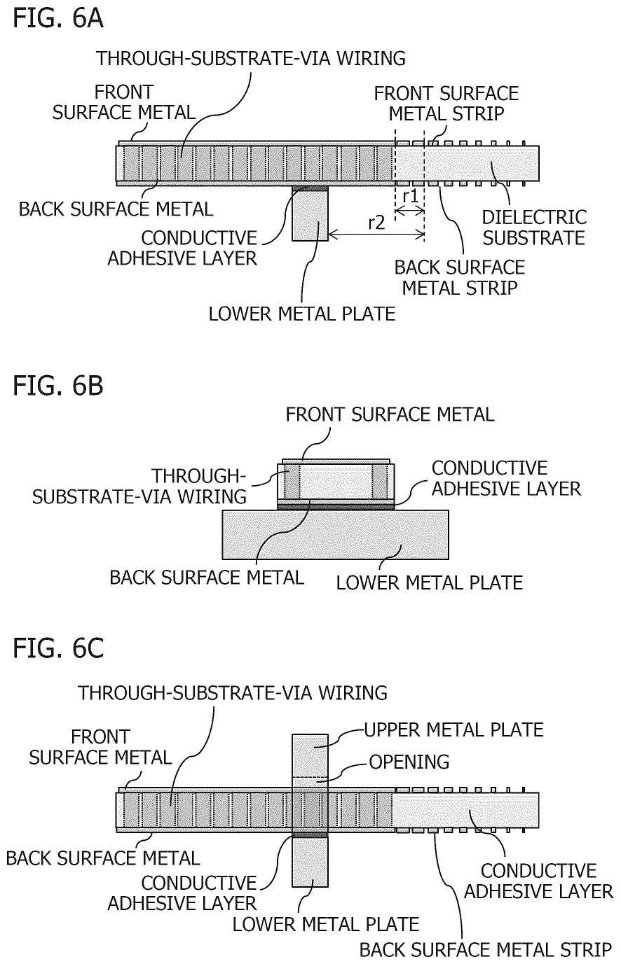

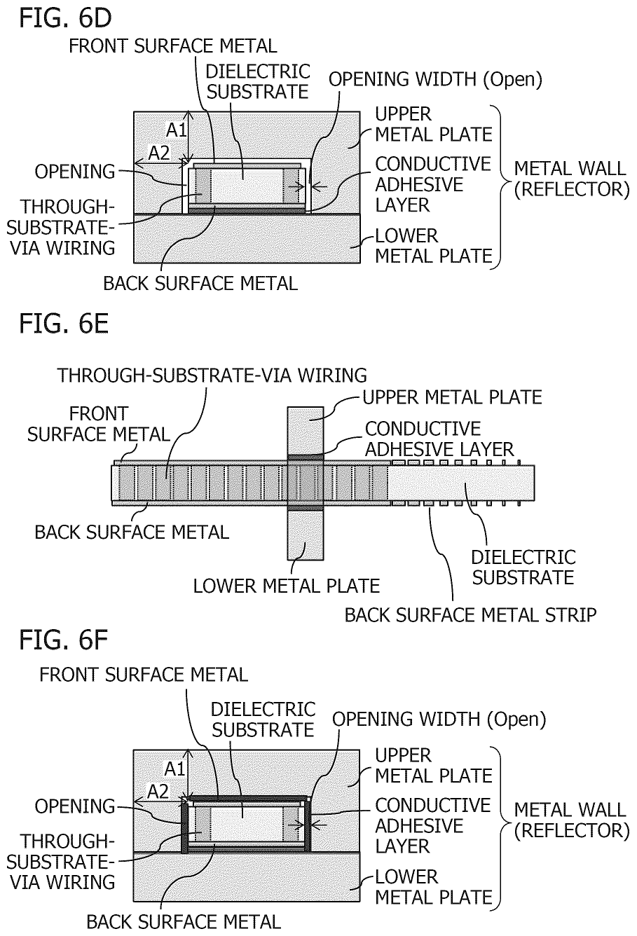

An example of a method of manufacturing the antenna 200 in the modification of the first embodiment will be described. FIGS. 6A to 6F illustrate an example of a method of manufacturing the antenna 200. FIGS. 6A to 6F each illustrate, for example, a method of manufacturing the antenna 200 for each process. FIGS. 6A to 6F illustrate, for example, products in the middle and at the time of completion (such as the antenna 200 in the middle of being created) in the method of manufacturing the antenna 200.

### FIG. 6A: Lower Metal Plate Adhesion

The SIW antenna chip produced in the process illustrated in FIG. 3J is attached to the lower metal plate at a predetermined position using a conductive adhesive. For example, at 300 GHz, r1 is 0.16 mm, and the antenna gain is improved in the range where r2 is 0.4 mm to 0.7 mm, but r2 is desirably in the range of 0.5 mm to 0.65 mm.

FIG. 6B is a front view of the antenna being fabricated in FIG. 6A.

### FIG. 6C: Upper Metal Plate Mounting

A recessed upper metal plate having a groove larger than the SIW antenna size is mounted on the lower metal plate. Thereby, the SIW antenna structure having the opening in the modification of the first embodiment is completed.

FIG. 6D is a front view of the antenna. The antenna includes the metal wall (reflector) including an upper metal plate, a conductive adhesive layer, and a lower metal plate. The width (A1, A2) of the outer periphery of the metal wall is 0.3 mm, and the width (Open) of the opening is 0.02 mm.

### FIG. 6E: Upper Metal Plate Adhesion

The opening may be filled with a conductive adhesive. In this case, the process of FIG. 6E is performed.

FIG. 6F is a front view of the antenna in which the opening is filled with a conductive adhesive. As described above, the antenna includes the metal wall (reflector) including the upper metal plate, the conductive adhesive layer, and the lower metal plate.

In the above example, a lower metal plate of a flat plate is used, but grooves may also be provided in the upper and lower metal plates, and a configuration including a lower metal plate having a groove larger than the SIW antenna size and an upper metal plate of a flat plate is also acceptable.

In the above example, SiC is used as a dielectric substrate, but a dielectric substrate such as InP, GaAs, high-resistance Si, alumina, GaN, AlN, diamond, LTCC, quartz, polyimide, Teflon (registered trademark), or other high-dielectric ceramic may be used.

### Second Embodiment

A second embodiment will be described.

### Configuration Example of Antenna Array in Second Embodiment

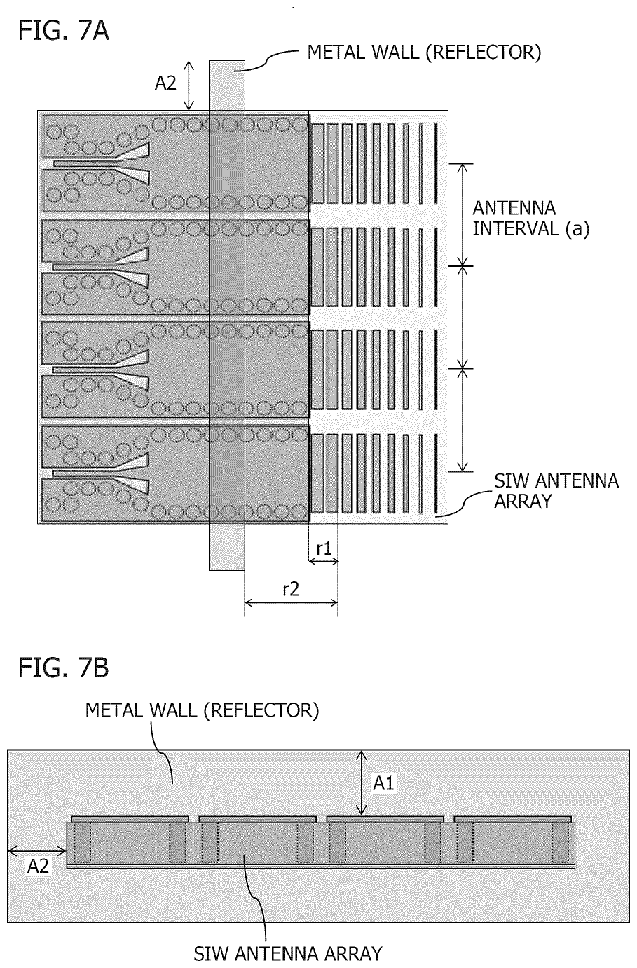

FIGS. 7A and 7B are diagrams illustrating a configuration example of an antenna array 300. The antenna array 300 (SIW antenna array) is obtained by arraying SIW antennas each including an SIW unit and a radiation unit including a plurality of metal strips, in horizontal parallel. In the SIW antenna array, a metal wall (reflector) surrounding the entire SIW unit of the SIW array antenna is disposed at a position with a second distance (r2) in the back lobe direction from a position with a first distance (r1) that is a distance from the interface between the SIW unit and the radiation unit in the main lobe direction at a predetermined frequency. The second distance is longer than the first distance (r1). At this time, at a predetermined frequency, r1 is ½ wavelength (λ/2) in the dielectric substrate, and r2 is in the range of Δ/2−λ/10 to λ/2+λ/5 of the air. The metal wall (reflector) has an outer periphery with a first width (A1) from the front and back surfaces of the SIW unit and a second width (A2) from a side surface of the SIW unit, and the first width (A1) is at least larger than λ/10 of the air. Note that the antenna array may be referred to as an array antenna.

### Effect of Antenna Array in Second Embodiment

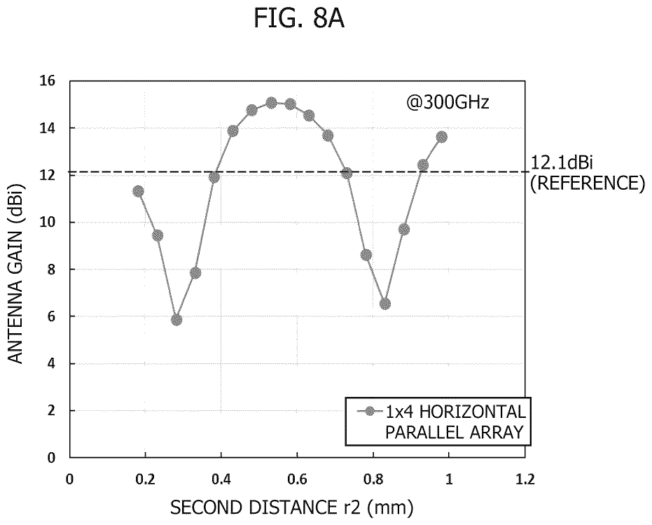

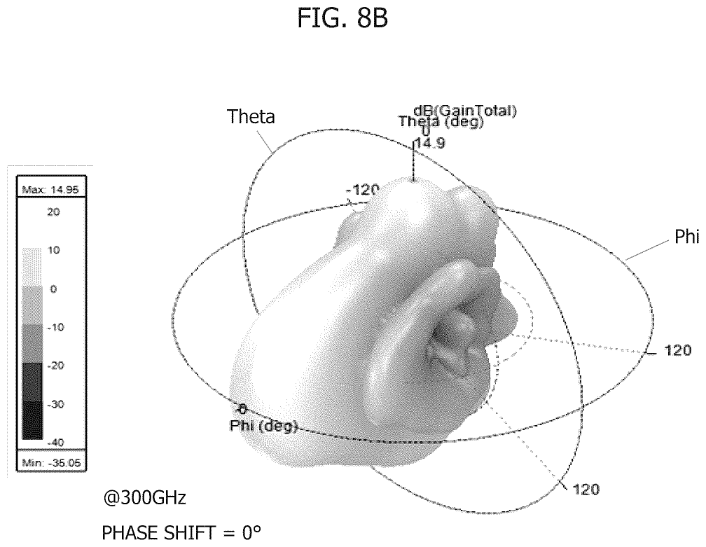

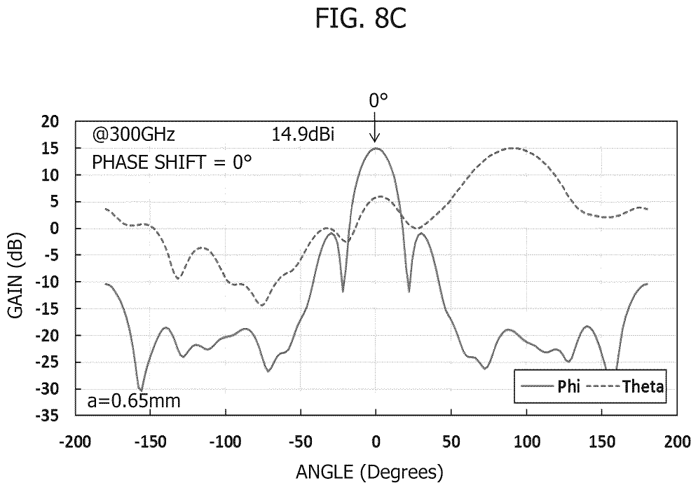

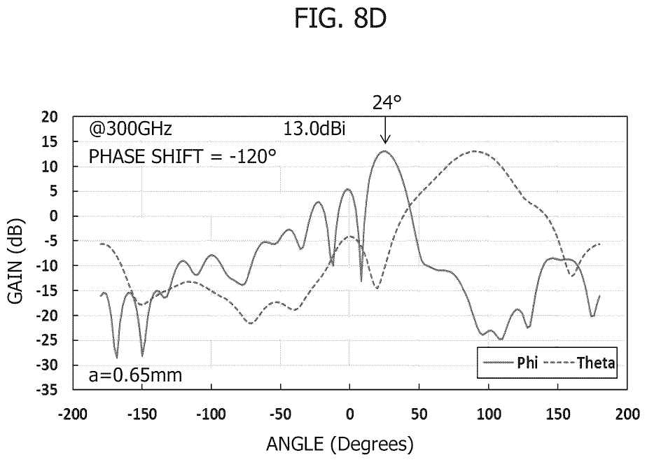

An effect of the SIW antenna array in the second embodiment will be described. FIGS. 8A to 8D illustrate examples of simulation results in the antenna array 300.

As illustrated in FIGS. 7A and 7B, the antenna array 300 has a configuration in which a metal wall (reflector) is arranged on an integrated SIW antenna array in which SIW antenna structures (for example, the antennas according to the first embodiment) are arrayed in horizontal parallel.

The dielectric substrate is an SiC substrate. The SiC substrate thickness is 100 μm. The SIW unit width (w) is set to 0.48 mm that is within the range of the TE10 mode. The diameter of the through-substrate-via wiring is set to 80 μm. The length (L) of the metal strip is 0.48 mm that is the same as the SIW unit width. The sum of the spacing(S) and the width (W) of each metal strip is ¼ wavelength (λ/4) of the dielectric substrate at a predetermined frequency, and the ratio of S:W is gradually changed from 1:9 to 9:1 in the main lobe direction. 24 in the SiC substrate having a dielectric constant of 9.74 is 80 μm at 300 GHz. The antenna interval (a) is set to 0.65 mm. The width (A1, A2) of the outer periphery of the metal wall (reflector) is set to 0.75 mm.

FIG. 8A illustrates an example of simulation results of the second distance (r2) dependency of the antenna gain of an SIW antenna structure 2 having a metal wall (reflector). The horizontal axis represents the second distance (r2), and the vertical axis represents the antenna gain. When the second distance (r2) is in the range of 0.4 mm to 0.7 mm, the antenna gain increases to be larger than the antenna gain 12.1 dBi of the reference SIW antenna array structure. This r2 corresponds to the range of λ/2−λ/10 to λ/2+λ/5 of the air.

FIG. 8B is a diagram illustrating an example of a radiation pattern when a phase shift between antennas is 0 degrees at 300 GHz. r2 is 0.58 mm. FIGS. 8C and 8D are diagrams illustrating examples of the angular dependence of the gain in the case where the phase shift between the antennas is 0 degrees and in the case where the phase shift is −120 degrees, respectively. The broken lines and the solid lines in the graphs indicate Theta (up and down) and Phi (horizontal) illustrated in FIG. 8B, respectively. By modulating the phase by −120 degrees between the antennas, it is possible to swing a beam by 24 degrees in the horizontal direction. At this time, a difference in the gain between the main lobe and the side lobe is about 8 dB.

In the SIW antenna array structure according to the second embodiment, since the antennas can be arranged in horizontal parallel at intervals narrower than one wavelength of the air, the beam can be swung in the horizontal direction.

### Method of Manufacturing Antenna Array in Second Embodiment

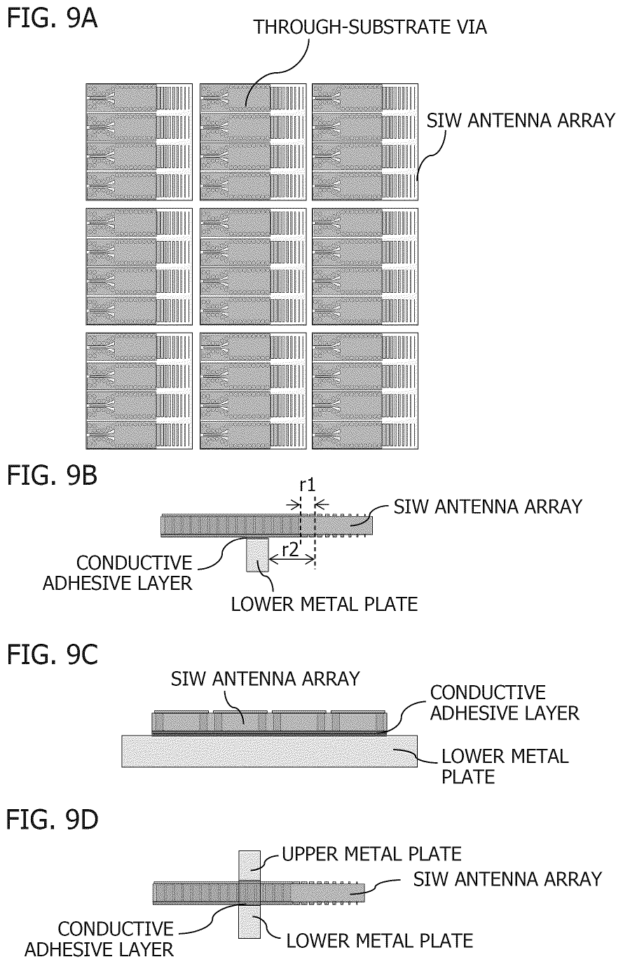

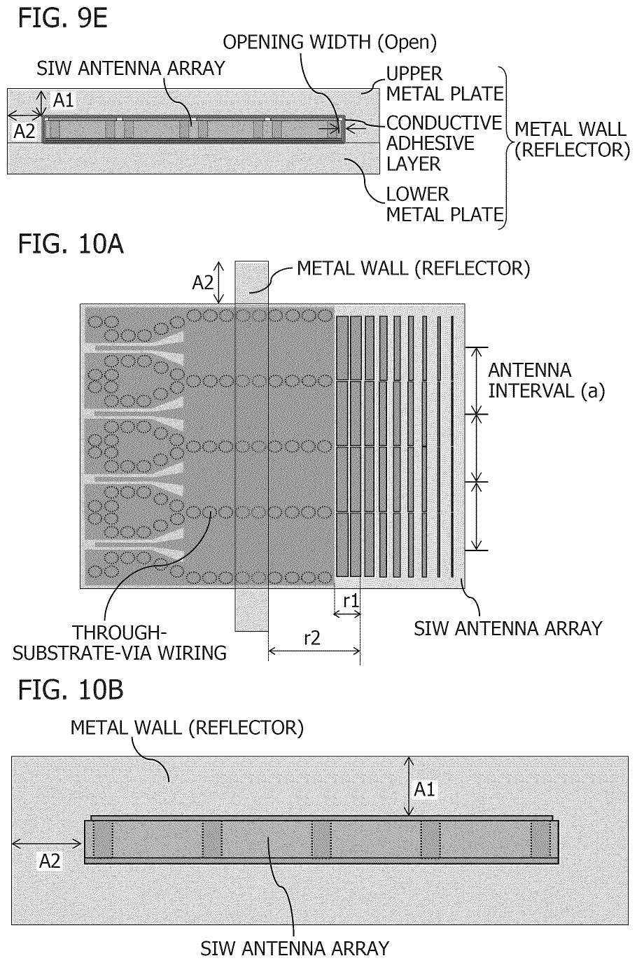

FIGS. 9A to 9E illustrate an example of a method of manufacturing the antenna array 300. Note that the steps leading to formation into chips are the same as those in the first embodiment. In the antenna array 300, for example, the SIW unit width (w) is 0.48 mm, and the antenna interval (a) is 0.65 mm.

### FIG. 9A: Chipping

A wafer on which a plurality of SIW antenna arrays are formed is formed into chips by ultrasonic blade dicing.

### FIG. 9B: Lower Metal Adhesion

The SIW antenna array chip is attached to the lower metal plate at a predetermined position using a conductive adhesive. For example, at 300 GHz, r1 is 0.16 mm, and r2 in which the antenna gain is improved is in the range of 0.4 mm to 0.7 mm, but r2 is desirably in the range of 0.5 mm to 0.65 mm. FIG. 9C is a front view of the antenna array.

### FIG. 9D: Upper Metal Adhesion

A recessed upper metal plate having a groove larger than the SIW antenna array size is mounted on the lower metal plate, and the gap is filled with a conductive adhesive, thereby the SIW antenna array structure is completed. FIG. 9E is a front view of the antenna array. The antenna array includes a metal wall (reflector plate) including an upper metal plate, a conductive adhesive layer, and a lower metal plate. The width (A1, A2) of the outer periphery of the metal wall is 0.75 mm, and the width (Open) of the opening is 0.02 mm. It is unnecessary to fill the opening with a conductive adhesive.

### Modification of Second Embodiment

A modification of the second embodiment will be described.

### Configuration Example of Antenna Array in Modification of Second Embodiment

FIGS. 10A and 10B are diagrams illustrating a configuration example of an antenna array 400. The antenna array 400 shares the through-substrate vias of the SIW units of adjacent SIW antennas. In addition, the metal strip of each radiation part may be connected.

### Effect of Antenna Array in Modification of Second Embodiment

The antenna array 400 according to the modification of the second embodiment shares the through-substrate via wiring of the SIW antenna structure to shorten the antenna interval (a). FIGS. 10A and 10B illustrate a top view and a front view, respectively. The dielectric substrate is an SiC substrate. The SiC substrate thickness is 100 μm. The SIW unit width (w) is set to 0.48 mm within the range of the TE10 mode. The diameter of the through-substrate-via wiring is set to 80 μm. The length (L) of the metal strip is 0.46 mm. The sum of the spacing(S) and the width (W) of each metal strip is ¼ wavelength (λ/4) of the dielectric substrate at a predetermined frequency, and the ratio of S:W is gradually changed from 1:9 to 9:1 in the main lobe direction. λ/4 in the SiC substrate having a dielectric constant of 9.74 is 80 μm at 300 GHz. The antenna interval (a) is 0.48 mm, which is smaller than 2/2 (0.5 mm) of the air. The width (A1, A2) of the outer periphery of the metal wall is set to 0.75 mm.

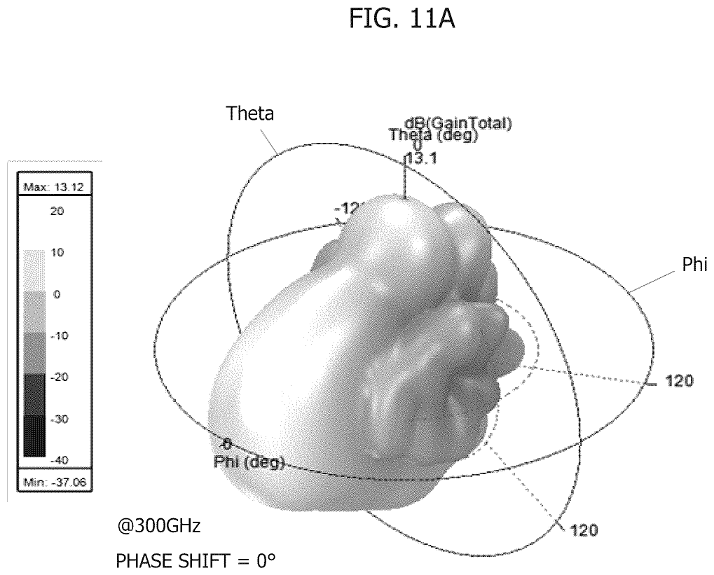

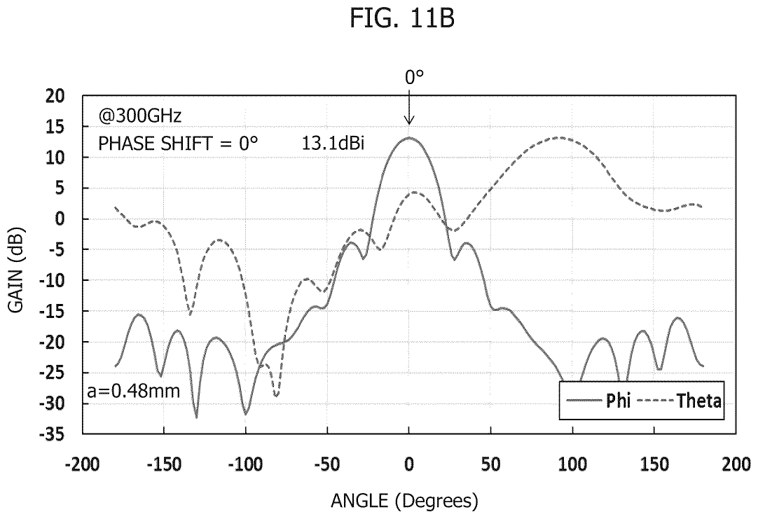

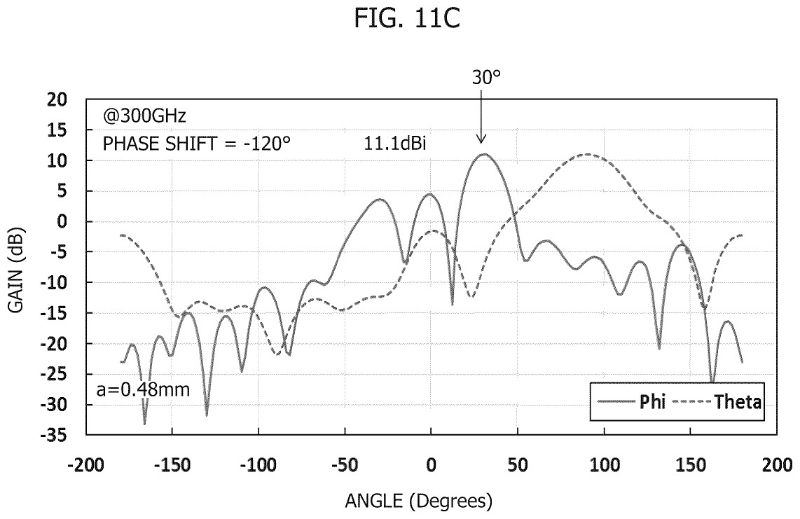

FIGS. 11A to 11C illustrate examples of simulation results of the antenna array 400. FIG. 11A illustrates an example of a radiation pattern when a phase shift between antennas is 0 degrees at 300 GHz. r2 is 0.58 mm. FIGS. 11B and 11C illustrate examples of the angular dependence of the gain in the case where the phase shift between the antennas is 0 degrees and in the case where the phase shift is −120 degrees, respectively. By modulating the phase by −120 degrees between the respective antennas, it is possible to swing the beam by 30 degrees in the horizontal direction, and by shortening the antenna interval, it is possible to increase the beam swing angle. At this time, a difference in the gain between the main lobe and the side lobe is about 6 dB. In the above, the metal strips between the antennas are not electrically connected, but may be electrically connected.

### Method of Manufacturing Antenna Array in Modification of Second Embodiment

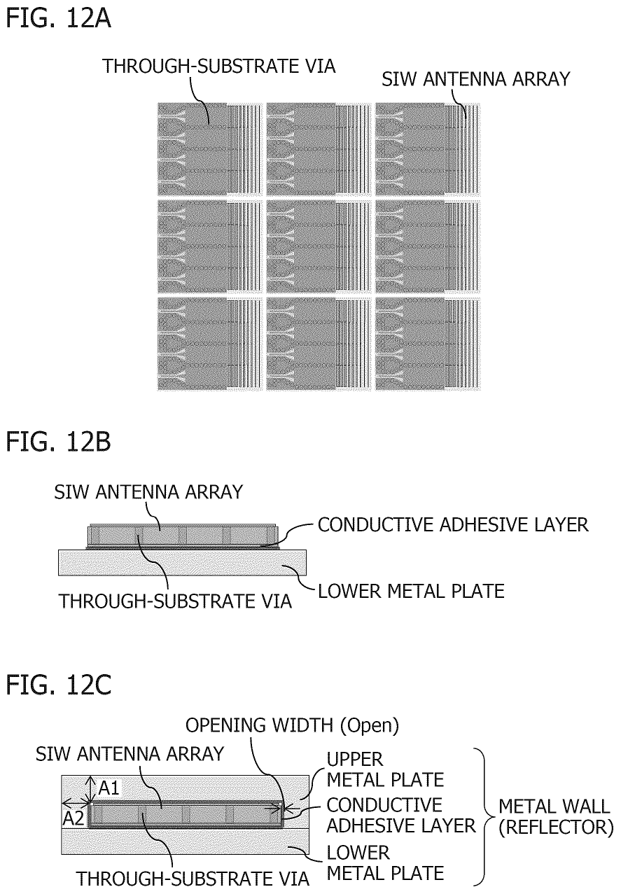

FIGS. 12A to 12C illustrate an example of a method of manufacturing the antenna array 400. The antenna array according to the modification of the second embodiment shares the through-substrate via between the SIW antennas and reduces the antenna interval. At this time, the SIW unit width (w) is 0.48 mm, and the antenna interval (a) is also 0.48 mm. The length (L) of the metal strip is 0.46 mm. The metal strips of each antenna may be electrically connected.

### FIG. 12A: Chipping

A wafer on which a plurality of SIW antenna arrays are formed is formed into chips by ultrasonic blade dicing.

### FIG. 12B: Lower Metal Plate Adhesion

The SIW antenna array chip is attached to the lower metal plate at a predetermined position using a conductive adhesive. For example, at 300 GHz, r1 is 0.16 mm, and r2 in which the antenna gain is improved is in the range of 0.4 mm to 0.7 mm, but r2 is desirably in the range of 0.5 mm to 0.65 mm.

### FIG. 12C: Upper Metal Plate Adhesion

A recessed upper metal plate having a groove larger than the SIW antenna array size is mounted on the lower metal plate, and the gap is filled with a conductive adhesive, thereby the SIW antenna array structure is completed. The antenna array includes a metal wall (reflector) including an upper metal plate, a conductive adhesive layer, and a lower metal plate. The width (A1, A2) of the outer periphery of the metal wall is 0.75 mm, and the width (Open) of the opening is 0.02 mm. It is unnecessary to fill the opening with a conductive adhesive.

In the SIW antenna array structure of the antenna array in the modification of the second embodiment, since the antenna interval can be shortened to less than λ/2 of the air, the beam swing angle in the horizontal direction can be increased.

### Third Embodiment

A third embodiment will be described.

### Configuration Example of Antenna Array in Third Embodiment

In the second embodiment, SIW antennas are arrayed in the horizontal direction. In the third embodiment, an SIW antenna array structure in which SIW antennas are stacked in the vertical direction is employed. In order to suppress unnecessary grating lobes, at least the antenna interval is preferably set to be less than one wavelength (λ) of the air also in the vertical direction, which is desirably λ/2. In the third embodiment, the thickness in the vertical direction is controlled.

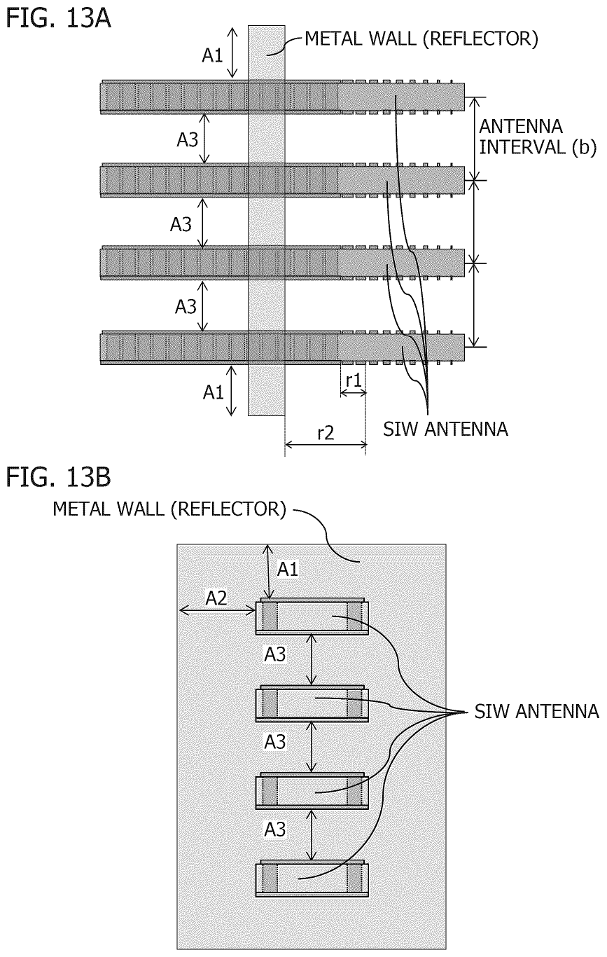

FIGS. 13A and 13B are diagrams illustrating a configuration example of an antenna array 500. The antenna array 500 according to the third embodiment is an SIW antenna array in which SIW antennas each including an SIW unit and a radiation unit including a plurality of metal strips are arrayed in vertical parallel, and a metal wall (reflector) surrounding the SIW units of the respective SIW antennas is disposed at a position with a second distance (r2) in the back lobe direction from a position with a first distance (r1) that is a distance from the interface between the SIW unit and the radiation unit in the main lobe direction at a predetermined frequency. The second distance (r2) is longer than the first distance (r1).

At this time, at a predetermined frequency, r1 is ½ wavelength (λ/2) in the dielectric substrate, and r2 is in the range of λ/2−λ/10 to λ/2+λ/5 of the air. The metal wall (reflector) includes an outer periphery having a first width (A1) from the front and back surfaces of the SIW unit and a second width (A2) from the side surface of the SIW unit, and a third width (A3) between adjacent SIW units. The first width (A1) is larger than at least λ/10 of the air, and the third width (A3) is in the range of at least λ/10 of the air to a difference between λ of the air and the thickness of the SIW unit.

### Effect of Antenna Array in Third Embodiment

FIGS. 13A and 13B are a cross-sectional view and a front view, respectively, and have a configuration in which a metal wall (reflector) is arranged in an SIW antenna array in which SIW antenna structures are arrayed in vertical parallel. The width (A1, A2) of the outer periphery of the metal wall (reflector) is set to 0.75 mm. The antenna interval (b) is set to 0.4 mm, and the third width (A3) of the metal wall (reflector) is set to 0.28 mm. r2 is 0.58 mm.

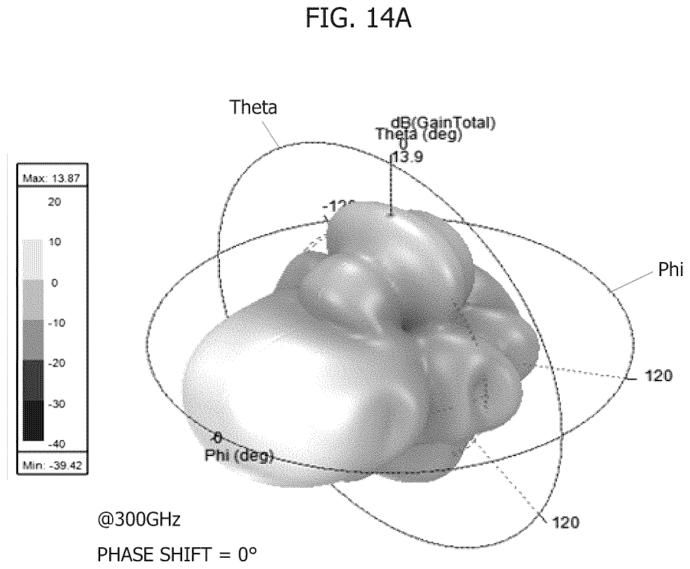

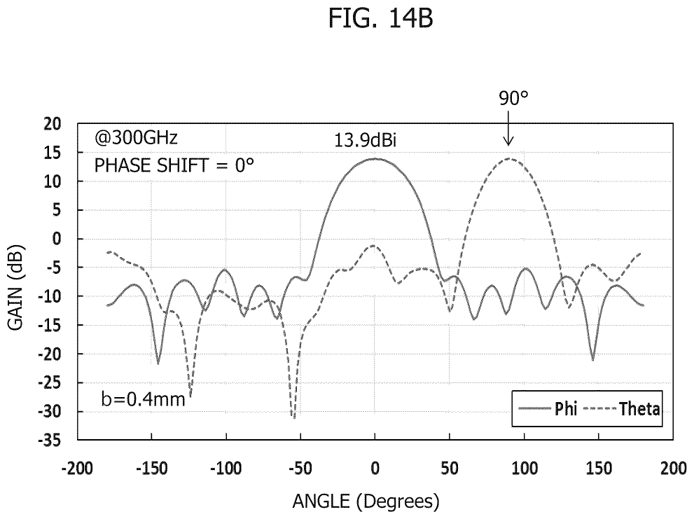

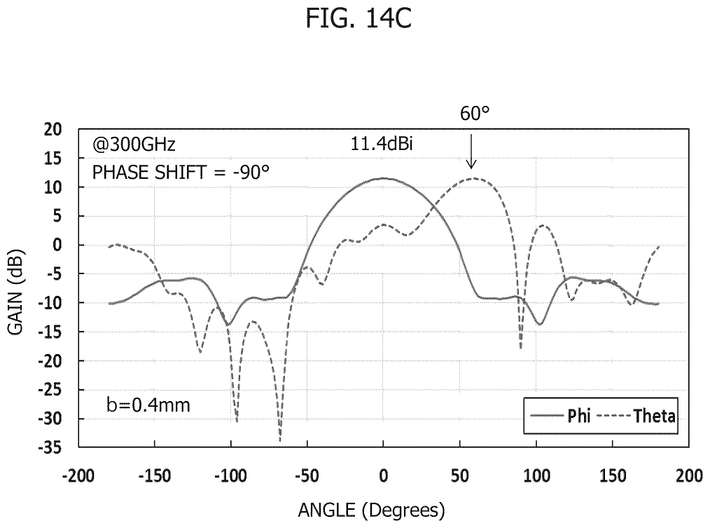

FIGS. 14A to 14C illustrate examples of simulations of the antenna array 500. FIG. 14A illustrates an example of a radiation pattern when a phase shift between antennas is 0 degrees at 300 GHz. FIGS. 14B and 14C illustrate examples of the angular dependence of the gain in the case where the phase shift between the antennas is 0 degrees and in the case where the phase shift is −90 degrees, respectively. The broken lines and the solid lines in the graphs indicate Theta (up and down) and Phi (horizontal) illustrated in FIG. 14A, respectively. By modulating the phase by −90 degrees between the antennas, it is possible to swing a beam by 30 degrees in the vertical direction. At this time, a difference in the gain between the main lobe and the side lobe is about 8 dB. Since the antenna is thinned by the SIW structure and the distance between the antennas can be shortened, the beam can be greatly swung even with a small phase shift.

### Method of Manufacturing Antenna Array in Third Embodiment

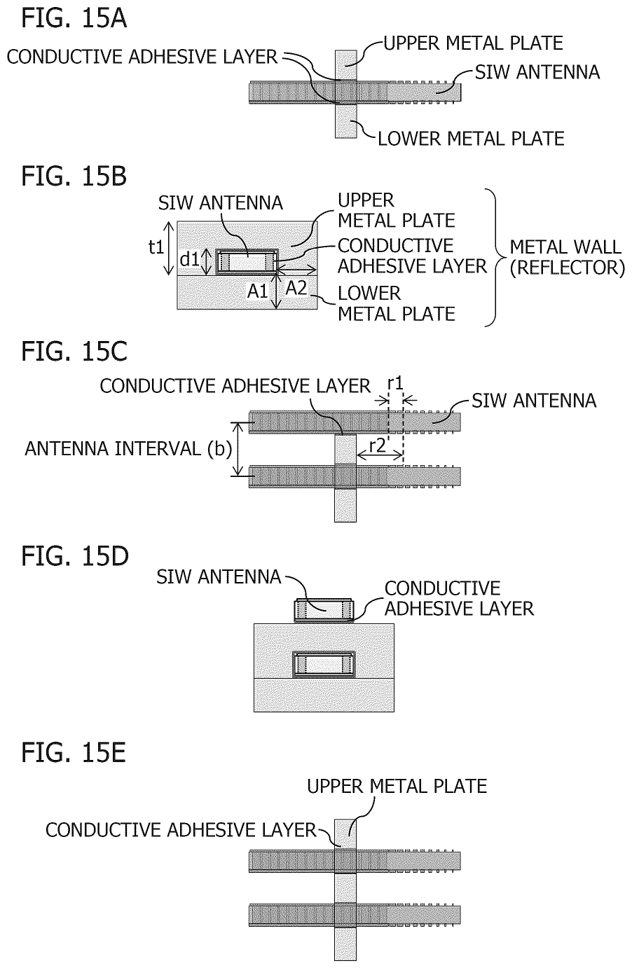

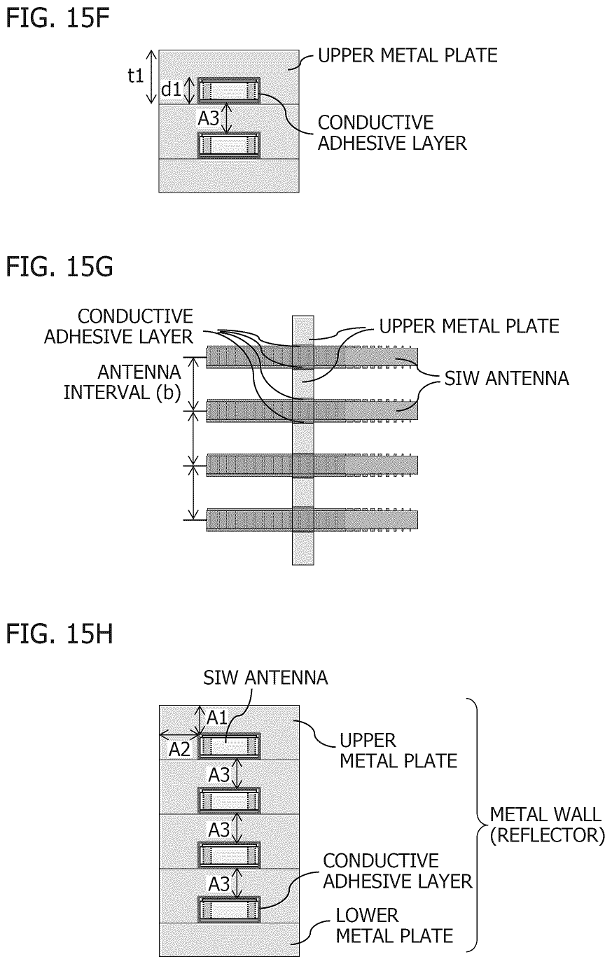

FIGS. 15A to 15H illustrate an example of a method of manufacturing the antenna array 500. FIGS. 15A and 15B illustrate examples of a cross-sectional view and a front view of an SIW antenna to be used.

### FIG. 15C: Adhesion

On the upper metal plate of the SIW antenna, an SIW antenna chip is attached again at a predetermined position with a conductive adhesive. FIG. 15D is a front view in the step of FIG. 15C. For example, at 300 GHz, r1 is 0.16 mm, and r2 in which the antenna gain is improved is in the range of 0.4 mm to 0.7 mm, but r2 is desirably in the range of 0.5 mm to 0.65 mm. Further, in order to set the antenna interval (b) to 0.4 mm, the thickness (t1) of the upper metal plate is set to 0.4 mm and the depth (d1) of the groove is set to 0.15 mm. The width (A1, A2) of the outer periphery of the metal wall (reflector) is set to 0.75 mm. The third width (A3) of the metal wall (reflector) is 0.25 mm+the thickness of the conductive adhesive layer (approximately 35 μm).

### FIG. 15E: Upper Metal Plate Mounting

Again, a recessed upper metal plate having a groove larger than the SIW antenna array size is mounted on a recessed upper metal plate placed below, and the gap is filled with a conductive adhesive. FIG. 15F is a front view in the step of FIG. 15E.

### FIG. 15G: Repeat

By repeating the above steps, an SIW antenna array structure in which four stages are stacked in the vertical direction with the antenna interval (b) of 0.4 mm is completed. FIG. 15H is a front view of the completed antenna. The antenna includes the metal wall (reflector) including an upper metal plate, a conductive adhesive layer, and a lower metal plate. It is unnecessary to fill the opening with a conductive adhesive.

In the SIW antenna array structure according to the third embodiment, since the antennas can be arranged in vertical parallel at intervals narrower than one wavelength of the air, the beam can be swung in the vertical direction.

### Modification of Third Embodiment

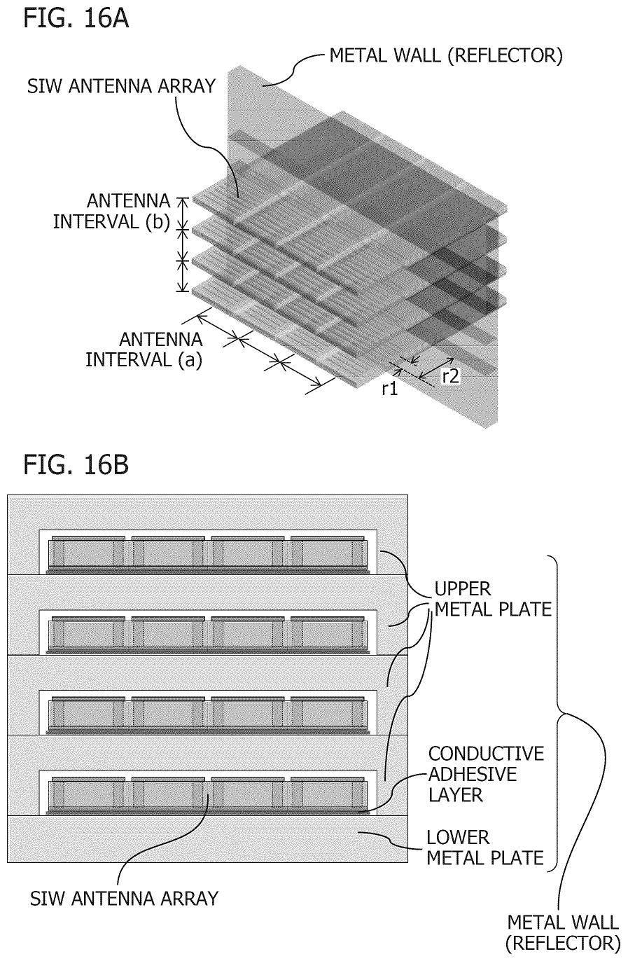

FIGS. 16A and 16B are diagrams illustrating a configuration example of an antenna array 600. The antenna array 600 according to a modification of the third embodiment is an SIW antenna array structure in which SIW antenna arrays with the antenna interval (a) of 0.65 mm of the second embodiment are stacked in the vertical direction with the antenna interval (b) of 0.4 mm. FIGS. 16A and 16B are diagrams illustrating examples of an overhead view and a front view of the SIW antenna array structure.

For example, at 300 GHz, r1 is 0.16 mm, and r2 in which the antenna gain is improved is in the range of 0.4 mm to 0.7 mm, but r2 is desirably in the range of 0.5 mm to 0.65 mm. Further, in order to set the antenna interval (b) to 0.4 mm, the thickness (t1) of the upper metal plate is set to 0.4 mm and the depth (d1) of the groove is set to 0.15 mm. The width (A1, A2) of the outer periphery of the metal wall (reflector) is set to 0.75 mm. The third width (A3) of the metal wall (reflector) is 0.25 mm+the thickness of the conductive adhesive layer (approximately 20 μm). The antenna includes the metal wall (reflector) including an upper metal plate, a conductive adhesive layer, and a lower metal plate. The opening may be filled with a conductive adhesive. At this time, the maximum antenna gain is 17.8 dBi at 300 GHz.

In the SIW antenna array structure according to the modification, since the antennas can be arranged in vertical parallel and horizontal parallel at intervals narrower than one wavelength of the air, the beam can be swung in the vertical and horizontal directions. Furthermore, in the SIW antenna array with the antenna interval (a) of 0.48 mm according to the modification of the second embodiment, it is possible to swing the beam at a wider angle.

Although the cases where the SIW antennas and the antenna arrays are vertically stacked in four stages have been described, the SIW antennas and the antenna arrays may be stacked in any number of stages.

Moreover, in the above example, an example in which SiC is used for a dielectric substrate has been described, but a dielectric substrate such as InP, GaAs, high-resistance Si, alumina, GaN, AlN, diamond, LTCC, quartz, polyimide, Teflon, or other high-dielectric ceramic may be used.

### Fourth Embodiment

A fourth embodiment will be described.

### Configuration Example of Antenna Module in Fourth Embodiment

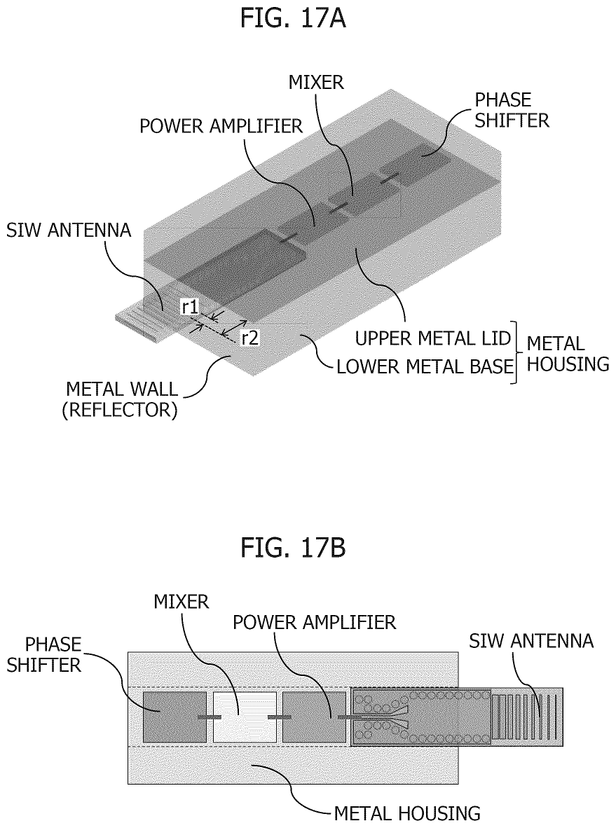

FIGS. 17A and 17B are diagrams illustrating a configuration example of an antenna module 700. The antenna module 700 according to the fourth embodiment is an example of an amplifier integrated antenna module in which high-frequency semiconductor circuit chips such as an amplifier, a mixer, and a phase shifter, an SIW antenna, and an antenna array are mounted on a metal housing.

First, FIGS. 17A and 17B illustrate an overhead view and a top view of an amplifier integrated antenna module in which high-frequency semiconductor circuit chips such as a power amplifier, a mixer, and a phase shifter, and an SIW antenna are mounted on a metal housing. The SIW antenna chip is attached to a lower metal base of the metal housing at a predetermined position using a conductive adhesive (not illustrated). For example, at 300 GHz, r1 is 0.16 mm, and r2 in which the antenna gain is improved is in the range of 0.4 mm to 0.7 mm, but r2 is desirably in the range of 0.5 mm to 0.65 mm. Further, sub-terahertz band power amplifier, mixer, and phase shifter chips are sequentially attached to the lower metal base of the metal housing. Thereafter, the SIW antenna, the power amplifier, the mixer, and the phase shifter are connected. Thereafter, a recessed upper metal lid having a groove larger than the sizes of the SIW antenna, the power amplifier, the mixer, and the phase shifter is put on to complete the amplifier integrated antenna module of the fourth embodiment. The side surface of the metal housing functions as a metal wall (reflector).

### Configuration Example of Antenna Module in First Modification of Fourth Embodiment

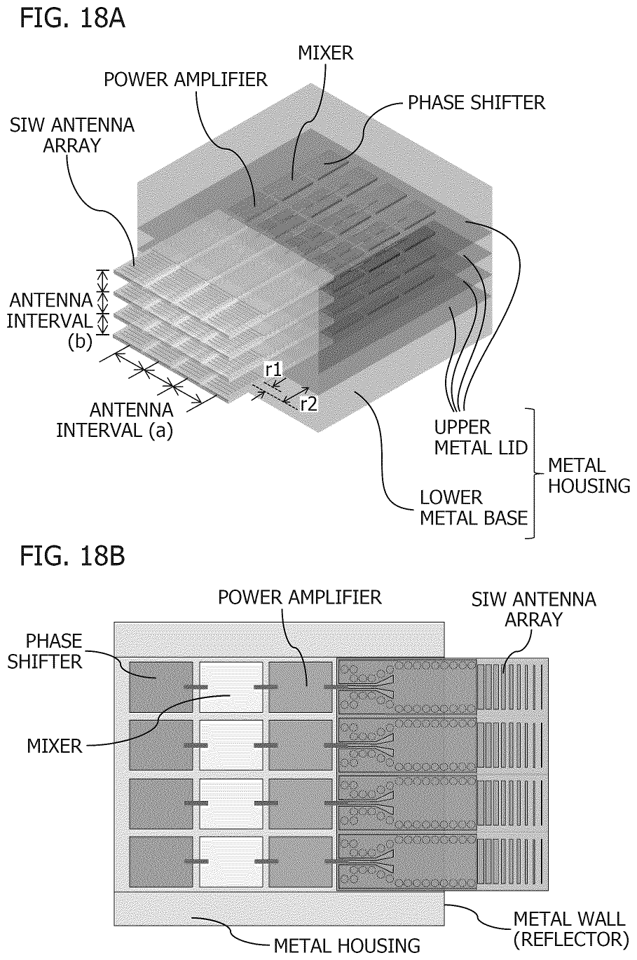

FIGS. 18A and 18B are diagrams illustrating a configuration example of an antenna module 800. FIGS. 18A and 18B illustrate an overhead view and a top view of the antenna module 800 according to a first modification of the fourth embodiment. An SIW antenna array chip having an antenna interval (a) of 0.65 mm is attached to a lower metal base of a metal housing at a predetermined position using a conductive adhesive (not illustrated). For example, at 300 GHz, r1 is 0.16 mm, and r2 in which the antenna gain is improved is in the range of 0.4 mm to 0.7 mm, but r2 is desirably in the range of 0.5 mm to 0.65 mm. Further, sub-terahertz band power amplifier, mixer, and phase shifter chips are sequentially attached to the lower metal base of the metal housing. Thereafter, the SIW antenna array, the power amplifier, the mixer, and the phase shifter are connected. Thereafter, a recessed upper metal lid having a groove larger than the sizes of the SIW antenna array, the power amplifier, the mixer, and the phase shifter is put on. At this time, in order to set the antenna interval (b) to 0.4 mm, the thickness of the upper metal lid is set to 0.4 mm, and the depth of the groove is set to 0.15 mm. In addition, the gap between the SIW unit and the metal housing may be filled with a conductive adhesive. By repeating this procedure, an amplifier integrated antenna module in which four stages are stacked in the vertical direction with the antenna interval (b) of 0.4 mm is completed. The side surface of the metal housing functions as a metal wall (reflector).

Although an example using a flat lower metal base has been described, grooves may be provided in the upper metal lid and the lower metal base, or a groove may be provided in the lower metal base and use a flat upper metal plate.

### Configuration Example of Antenna Module in Second Modification of Fourth Embodiment

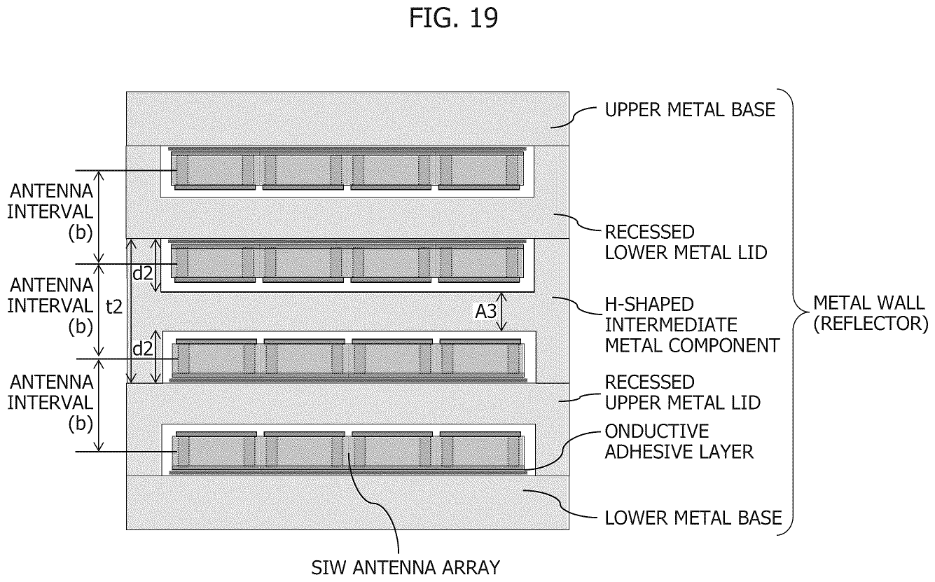

FIG. 19 is a diagram illustrating a configuration example of an antenna module 900. In the antenna module 900 in a second modification of the fourth embodiment, an SIW antenna array chip having an antenna interval (a) of 0.65 mm is attached to a lower (upper) metal base of a metal housing at a predetermined position using a conductive adhesive. For example, at 300 GHz, r1 is 0.16 mm, and r2 in which the antenna gain is improved is in the range of 0.4 mm to 0.7 mm, but r2 is desirably in the range of 0.5 mm to 0.65 mm. Further, sub-terahertz band power amplifier, mixer, and phase shifter chips (not illustrated) are sequentially attached to the lower (upper) metal base of the metal housing. Thereafter, the SIW antenna array, the power amplifier, the mixer, and the phase shifter are connected. Thereafter, a recessed upper (lower) metal lid having a groove larger than the sizes of the SIW antenna array, the power amplifier, the mixer, and the phase shifter is put on. They are attached by using an H-shaped intermediate metal part having a groove larger than the sizes of the SIW antenna array, the power amplifier, the mixer, and the phase shifter, whereby an amplifier integrated antenna module of the second modification of the fourth embodiment is completed. In order to set the antenna interval (b) to 0.4 mm, the thickness (t2) of the H-shaped intermediate metal part is set to 0.57 mm, and the depths (d2) of the grooves on both sides are set to 0.2 mm. At this time, the third width (A3) of the H-shaped intermediate metal part is 0.17 mm, which is larger than λ/10 of the air. The side surface of the metal housing functions as a metal wall (reflector).

In FIG. 19, an example in which SIW antenna arrays in each of which four SIW antennas are arrayed in horizontal parallel are stacked in four stages in the vertical direction has been described, but a larger number of arrays may be arranged.

### Configuration Example of Antenna Module in Third Modification of Fourth Embodiment

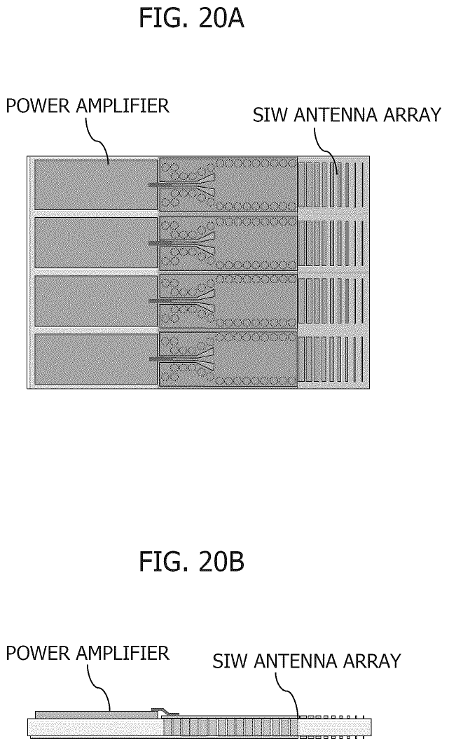

FIGS. 20A and 20B are diagrams illustrating a configuration example of an antenna module 1000. FIG. 20A is a top view, and FIG. 20B is a cross-sectional view. The thermal conductivities (see Table 1 in FIG. 21) of an InP substrate and a GaAs substrate on which a sub-terahertz band power amplifier is manufactured are as low as 68 W/mK and 46 W/mK, respectively. On the other hand, since the thermal conductivity of an SiC substrate that is a dielectric substrate of an SIW antenna array is as high as 490 W/mK, the SiC substrate can also be used as a heat spreader material. Therefore, by mounting a sub-terahertz band power amplifier on the SIW antenna array, the heat dissipation effect of the power amplifier can be improved. Instead of the SiC substrate, a high-resistance Si substrate (148 W/mK), a GaN substrate (230 W/mK), an AlN substrate (340 W/mK), or a diamond substrate (2000 W/mK) having higher thermal conductivity than an InP or GaAs substrate can also be used as a dielectric substrate. Further, in the case of a GaN HEMT, an SiC substrate, a GaN substrate, an AlN substrate, and a high-resistance Si substrate that are used for GaN epitaxial crystal growth can be directly used as a dielectric substrate. Although the embodiment is an example of a transmission-side antenna module using a power amplifier, a reception-side antenna module using a low noise amplifier (LNA) may be configured.

By equipping a transmission/reception device with a substrate integrated waveguide antenna and an antenna array structure, it is possible to provide a communication system device for the Beyond 5G/6G.

### Other Embodiments

The above-described embodiments may be combined with each other. For example, arrayed antennas may be either antennas 100 or 200, or both. Furthermore, for example, an antenna module or a transceiver may be configured using any one of or a combination of the antenna 100, the antenna 200, the antenna array 300, the antenna array 400, the antenna array 500, and the antenna array 600.

In addition, the components in each embodiment are not limited to the substances described in the examples. For example, there is a case where components may be replaced with other substances having similar actions, effects, or characteristics.

One disclosure can achieve both improvement in antenna gain and reduction in antenna interval.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A substrate integrated waveguide antenna comprising:
a substrate integrated waveguide, a radiator including a plurality of metal strips, and a metal wall, wherein
the substrate integrated waveguide and the radiator are connected on a dielectric substrate, and
the metal wall is disposed at a second position with a second distance longer than a first distance in a direction toward the substrate integrated waveguide from a first position, the first position being a position with the first distance in a direction from an interface at which the substrate integrated waveguide and the radiator are connected toward the radiator.

2. The substrate integrated waveguide antenna according to claim 1, wherein
the first distance is a distance that is ½ of a wavelength of a predetermined frequency in the dielectric substrate, and the second distance is in a range of ½− 1/10 to ½+⅕ of the wavelength of the predetermined frequency in air.

3. The substrate integrated waveguide antenna according to claim 1, wherein
the metal wall is disposed so as to surround the substrate integrated waveguide.

4. The substrate integrated waveguide antenna according to claim 1, wherein
the metal wall includes an outer periphery having a first width from front and back surfaces of the substrate integrated waveguide and a second width from a side surface of the substrate integrated waveguide, and the first width is 1/10 or more of a wavelength of a predetermined frequency in air.

5. The substrate integrated waveguide antenna according to claim 1, wherein
the metal wall includes an opening larger than a size of the substrate integrated waveguide, and
any surface of the metal wall is in contact with the substrate integrated waveguide.

6. The substrate integrated waveguide antenna according to claim 1, wherein
the substrate integrated waveguide is in a single mode at a predetermined frequency.

7. The substrate integrated waveguide antenna according to claim 1, wherein
the substrate integrated waveguide includes a plurality of through-substrate-via wirings, and
a length of each of the plurality of metal strips ranges from a difference between a width of the substrate integrated waveguide and ½ of a diameter of each of the plurality of through-substrate via wirings to a sum of the width of the substrate integrated waveguide and ½ of the diameter of each of the plurality of through-substrate via wirings.

8. The substrate integrated waveguide antenna according to claim 1, wherein
a sum of a width and an interval of each of the plurality of metal strips is ¼ of a wavelength of a predetermined frequency in the dielectric substrate, and
a ratio of the width to the interval of each of the plurality of metal strips changes from 9:1 to 1:9 as the ratio of the width to the interval decreases in a direction from the interface to the radiator.

9. An array antenna comprising:
a plurality of substrate integrated waveguide antennas, N pieces of the substrate integrated waveguide antennas being arranged so as to overlap each other in a vertical direction, M pieces of the substrate integrated waveguide antennas being arranged side by side horizontally, wherein
each of the plurality of substrate integrated waveguide antennas includes a substrate integrated waveguide, a radiator including a plurality of metal strips, and a metal wall, the substrate integrated waveguide and the radiator are connected on a dielectric substrate, and the metal wall is disposed at a second position with a second distance longer than a first distance in a direction from a first position toward the substrate integrated waveguide, the first position being a position with the first distance in a direction from an interface at which the substrate integrated waveguide and the radiator are connected toward the radiator.

10. The array antenna according to claim 9, wherein
the metal wall has a third width between the substrate integrated waveguides of the substrate integrated waveguide antennas adjacent to each other in the vertical direction, and the third width is in a range of a difference between 1/10 to 1 of a wavelength of a predetermined frequency in air and a thickness of the substrate integrated waveguide.

11. The array antenna according to claim 9, wherein
an interval between the substrate integrated waveguide antennas adjacent to each other is smaller than a wavelength of a predetermined frequency in air.

12. The array antenna according to claim 9, wherein
each of the plurality of substrate integrated waveguide antennas includes a plurality of through-substrate-via wirings, and
the substrate integrated waveguide antennas adjacent to each other partially share the plurality of through-substrate-via wirings.

13. The array antenna according to claim 9, wherein
the first distance is a distance that is ½ of a wavelength of a predetermined frequency in the dielectric substrate, and the second distance is in a range of ½− 1/10 to ½+⅕ of the wavelength of the predetermined frequency in air.

14. The array antenna according to claim 9, wherein
the metal wall is disposed so as to surround the substrate integrated waveguide.

15. The array antenna according to claim 9, wherein
the metal wall includes an outer periphery having a first width from front and back surfaces of the substrate integrated waveguide and a second width from a side surface of the substrate integrated waveguide, and the first width is 1/10 or more of a wavelength of a predetermined frequency in air.

16. The array antenna according to claim 9, wherein
the metal wall includes an opening larger than a size of the substrate integrated waveguide, and
any surface of the metal wall is in contact with the substrate integrated waveguide.
